(19) United States
(12) Patent Application Publication
(10) Pub. No.: US 2022/0248719 A1
(43) Pub. Date: Aug. 11, 2022

(54) GASIFIED SOLUTIONS WITH IMPROVED SENSORY PROPERTIES

(71) Applicant: CARGILL, INCORPORATED, Wayzata, MN (US)

(72) Inventors: Dan S. GASPARD, Victoria, MN (US); Erin Kathleen MARASCO, Excelsior, MN (US); Rama Krishna SARANGAPANI, St. Michael, MN (US); Adam T. ZARTH, St. Louis Park, MN (US)

(73) Assignee: CARGILL, INCORPORATED, Wayzata, MN (US)

(21) Appl. No.: 17/594,172

(22) PCT Filed: Apr. 6, 2020
(86) PCT No.: PCT/US2020/026884

§ 371 Date: Oct. 5, 2021

Related U.S. Application Data
(60) Provisional application No. 62/832,250, filed on Apr. 10, 2019.

(51) Int. Cl. A23L 2/54; A23L 2/40; A23L 2/52; A23L 2/60; A23L 2/68; A23L 29/30

(52) U.S. Cl. CPC A23L 2/54; A23L 2/40; A23L 29/30; A23L 2/60; A23L 2/68; A23L 2/52

(57) ABSTRACT

This disclosure sets forth bubble modifiers capable of reducing mean bubble diameter of a gasified aqueous solution, e.g., a carbonated beverage. The bubble modifier may include one or more compounds selected from the group consisting of monocaffeoylquinic acids, dicaffeoylquinic acids, monoferuloylquinic acids, diferuloylquinic acids, monocoumaroylquinic acids, dicoumaroylquinic acids, and salts thereof. The bubble modifier desirably comprises less than 0.3% (wt) of malonate, malonic acid, oxalate, oxalic acid, lactate, lactic acid, succinate, succinic acid, malate, or malic acid; or less than 0.05% (wt) of pyruvate, pyruvic acid, fumarate, fumaric acid, tartrate, tartaric acid, sorbate, sorbic acid, acetate, or acetic acid; or less than about 0.05% (wt) of chlorophyll; or less than about 0.1% (wt) of furans, furan-containing chemicals, theobromine, theophylline, or trigonelline.

### CROSS REFERENCE TO RELATED APPLICATIONS

This application claims the benefit of: U.S. Application No. 62/830,443, filed Apr. 6, 2019 and entitled “Gasified Solutions With Improved Sensory Properties;” U.S. Application No. 62/832,250, filed Apr. 10, 2019 and entitled “Gasified Solutions With Improved Sensory Properties;” U.S. application Ser. No. 16/374,388, filed Apr. 3, 2019 and entitled “Steviol Glycoside Compositions With Reduced Surface Tension,” which was published Jul. 25, 2019 as US Patent Application Publication No. 2019/0223482; International Application No. PCT/US2018/054804, filed Oct. 8, 2018 and entitled “Steviol Glycoside Compositions With Reduced Surface Tension;” International Application No. PCT/US2018/054691, filed Oct. 5, 2018 and entitled “Steviol Glycoside Solubility Enhancers;” U.S. Provisional Application Ser. No. 62/569,279, filed Oct. 6, 2017, and entitled “Steviol Glycoside Solubility Enhancers;” and U.S. Provisional Application Ser. No. 62/676,722, filed May 25, 2018, and entitled “Methods for Making Yerba Mate Extract Composition.” The entirety of each of those applications is hereby incorporated by reference.

### FIELD

The present disclosure generally relates to gasified solutions, e.g., a carbonated beverage or a nitrogenated beverage, and more particularly provides gasified solutions with enhanced bubble properties.

### BACKGROUND

Gasified beverages are sold in very large volumes around the world. The bubbles in such beverages can enhance the appearance, flavor release, and mouthfeel of the beverage. Carbonated non-alcoholic beverages obtain their bubbles through carbonation, i.e., dissolved CO₂. Features that impact the number of bubbles likely to form in a single glass include interactions between dissolved CO₂, tiny gas pockets trapped within particles acting as bubble nucleation sites, and ascending bubble dynamics Alcoholic beverages can obtain bubbles through carbonation (e.g., sparkling wines) or through nitrogenation, i.e., dissolved nitrogen gas (e.g., beer). Some coffee drinks and energy drinks are nitrogenated to facilitate mouthfeel and flavor release.

Bubbles generally appear in carbonated beverages when concentration levels of CO₂ are 3-5 times higher than at the saturation equilibrium value and depend upon the pre-existing gas-liquid interfaces (Lubetkin & Blackwell, 1988; Wilt, 1986). Growth rate and ascending velocity of the bubbles are influenced by the concentration of carbon dioxide available in the liquid phase and by the presence of tensioactive molecules (proteins, sugar) in the solution and on the bubble wall, making it grow slower or faster (Jones, Evans, & Galvin, 1999; Odake, 2001).

The initial bubble size distribution in a beverage foam depends on the history of the bubble formation, i.e. the number of bubbles per unit of time, the shape and wetting properties of the cavities, the oversaturation of the liquid with gas, the rheological surface properties of the liquid and the velocity and direction of the flow of the liquid surrounding the bubble.

The gas phase in beverages can have a considerable effect on sensory properties, including visual appeal, mouthfeel, and flavor release. Overall, the benefits of bubbles on a sensory level is threefold: 1) visual appeal from frequency of bubble formation (Liger-Belair, 2006), 2) growth rate of bubbles ascending in the glass (Liger-Belair et al, 2012), 3) tingling sensation in mouth. A head of foam on a beverage may also make it more appealing. Also, the size distribution and the number of bubbles formed per unit of time impact the appearance and the stability foams. A wide bubble-size distribution can promote a sense of “prickly” bubbles or coarse foams. Smaller bubbles contribute to a more effervescent sensation or more creaminess of the foam. Studies by Barker et al. (2002) showed that consumers prefer smaller bubbles; in sensory studies, 87% of the panelists were able to correctly identify the more highly carbonated sample and 73% of the panelists perceived the sample containing the smaller bubbles as being more highly carbonated. In other related tests, the samples containing the smaller bubbles were consistently preferred over samples with larger, “normal”-sized bubbles.

### SUMMARY

The present disclosure generally relates to gasified aqueous solutions, e.g., gasified beverages, with bubble modifiers that enhance the bubble properties by reducing bubble size in the liquid phase, that reduce bubble size in a foam on the solution, and/or stabilize the foam on the solution.

### BRIEF DESCRIPTION OF THE FIGURES

FIG. 1 shows digital photos of bubbles for an aqueous steviol glycoside solution during and after sparging with air for 40 seconds.

FIG. 2A shows digital photos of bubbles for an aqueous steviol glycoside solution with bubble modifier after sparging with air for 40 seconds.

FIG. 2B shows digital photos of bubbles for an aqueous steviol glycoside solution with bubble modifier after sparging with air for 60 seconds.

FIG. 2C shows digital photos of bubbles for an aqueous steviol glycoside solution with bubble modifier after sparging with air to reach a final volume of 250 ml.

FIG. 3A shows digital photos of bubbles for a lemon-lime flavored steviol glycoside solution with bubble modifier after sparging with air for 40 seconds.

FIG. 3B shows digital photos of bubbles for a lemon-lime flavored steviol glycoside solution with bubble modifier after sparging with air for 60 seconds.

FIG. 3C shows digital photos of bubbles for a lemon-lime flavored steviol glycoside solution with bubble modifier after sparging with air to reach a final volume of 250 ml.

FIG. 4A shows digital photos of bubbles for a cola flavored steviol glycoside solution with bubble modifier after sparging with air for 40 seconds.

FIG. 4B shows digital photos of bubbles for a cola flavored steviol glycoside solution with bubble modifier after sparging with air for 40 seconds.

FIG. 4C shows digital photos of bubbles for a cola flavored steviol glycoside solution with bubble modifier after sparging with air to reach a final volume of 250 ml.

FIG. 5A shows digital photos of bubbles for a steviol glycoside solution during and after sparging with air or nitrogen gas for 40 seconds.

FIG. 5B shows digital photos of bubbles for a steviol glycoside solution with bubble modifier during and after sparging with air or nitrogen gas for 40 seconds.

FIG. 5C shows digital photos of bubbles for a steviol glycoside solution with bubble modifier and preservatives during and after sparging with air or nitrogen gas for 40 seconds.

FIG. 6A shows digital photos of bubbles for an orange flavored steviol glycoside solution during and after sparging with air or nitrogen gas for 40 seconds.

FIG. 6B shows digital photos of bubbles for an orange flavored steviol glycoside solution with bubble modifier during and after sparging with air or nitrogen gas for 40 seconds.

FIG. 7A is a graph reflecting mean foam bubble size over time for aqueous solutions sparged with air.

FIG. 7B is a graph reflecting mean foam bubble size over time for aqueous solutions sparged with nitrogen.

FIG. 7C is a graph reflecting mean foam bubble size over time for aqueous solutions sparged with air and nitrogen.

FIG. 7D is a graph reflecting mean foam bubble size over time for an orange flavored aqueous solution sparged with air and nitrogen.

FIG. 8 is a photograph of unsweetened carbonated water samples with different concentrations of bubble modifiers.

### DETAILED DESCRIPTION

The disclosure relates generally to bubble modifiers that can 1) reduce bubble size in gasified aqueous solutions, e.g., carbonated or nitrogenated beverages, and 2) when used in conjunction with steviol glycoside compounds in modified steviol glycoside solutions, increase foam volume and foam stability. This can improve sensory properties, e.g., visual appeal and mouthfeel, of beverages incorporating features in accordance with this disclosure.

As used herein, a gasified aqueous solution is an aqueous solution that contains dissolved gas at a level that will cause the solution to effervesce when at rest (i.e., not actively stirred or agitated) in a smooth-walled glass container. Whether a given solution will effervescence may depend on a number of factors, such as what pressure the solution is under and its temperature. For purposes of this disclosure, an aqueous solution may be deemed a gasified aqueous solution if it will effervesce when the solution is at 15.6° C. and under an ambient air pressure of 1 atmosphere; a temperature of 15.6° C. and an ambient air pressure of 1 atmosphere is referred to herein as “STP.”

As used herein, a modified steviol glycoside solution is an aqueous solution that contains both steviol glycoside and bubble modifier.

As the term is used herein, “steviol glycoside” refers to the total content of steviol glycoside compounds. The weight of a steviol glycoside and its constituent steviol glycoside compound(s) is determined on a dry (anhydrous) basis. Unless expressed herein otherwise, an “amount” of steviol glycoside will refer to the percentage by weight (% wt) of the total content of steviol glycoside compounds.

Unless otherwise expressly stated, ppm is on a weight basis. Percentages that are not otherwise defined herein are percentages by weight unless the context indicates otherwise.

As detailed below, solutions in accordance with this disclosure include a bubble modifier and may also include steviol glycoside.

### Bubble Modifier

Bubble modifiers disclosed herein can reduce the size of bubbles within gasified aqueous solutions and/or modify foaming characteristics of modified steviol glycoside solutions, e.g., by modifying the foam capacity (discussed below), the volumetric stability of the foam, the amount of foam produced, the foam expansion (discussed below), and/or the foam density. A bubble modifier may include a single bubble-modifying compound or more than one bubble-modifying compound.

Examples of bubble modifier compounds suitable for use in gasified aqueous solutions and modified steviol glycoside solutions of this disclosure include:
caffeic acid; an ester of caffeic acid; an ester of caffeic acid and quinic acid; a monocaffeoylquinic acid, namely an ester of caffeic acid and quinic acid comprising a single caffeic acid moiety, e.g., chlorogenic, cryptochlorogenic, or neochlorogenic acid (structures of each are provided herein); an ester of caffeic acid and quinic acid comprising more than one caffeic acid moiety, such as a dicaffeoylquinic acid, namely an ester of caffeic acid and quinic acid comprising two caffeic acid moieties, e.g., 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, or 4,5-dicaffeoylquinic acid (structures of each are provided herein);
ferulic acid; an ester of ferulic acid; an ester of ferulic acid and quinic acid; a monoferuloylquinic acid, namely an ester of ferulic acid and quinic acid comprising a single ferulic acid moiety, e.g., 3-O-feruloylquinic acid, 4-O-feruloylquinic acid, 5-O-feruloylquinic acid; an ester of ferulic acid and quinic acid comprising more than one ferulic acid moiety, such as a diferuloylquinic acid, namely an ester of ferulic acid and quinic acid comprising two ferulic acid moieties, e.g., 3,4-diferuloylquinic acid, 3,5-diferuloylquinic acid, and 4,5-diferuloylquinic acid;
quinic acid, an ester of quinic acid;
tartaric acid, a tartaric acid derivative, an ester of tartaric acid, an ester of a tartaric acid derivative;
3-(3,4-dihydroxyphenyl)lactic acid, a 3-(3,4-dihydroxyphenyl)lactic acid derivative, an ester of 3-(3,4-dihydroxyphenyl)lactic acid, an ester of a 3-(3,4-dihydroxyphenyl)lactic acid derivative;
p-coumaric acid, an ester of p-coumaric acid, an ester of p-coumaric acid and quinic acid, an ester of p-coumaric acid and quinic acid comprising a single p-coumaric acid moiety, an ester of p-coumaric acid and quinic acid comprising more than one p-coumaric acid moiety; and
sinapic acid, an ester of sinapic acid, an ester of sinapic acid and quinic acid, an ester of sinapic acid and quinic acid comprising a single sinapic acid moiety, an ester of sinapic acid and quinic acid comprising more than one sinapic acid moiety.

These bubble modifier compounds may be in their acid form or in a salt form, e.g., as a quaternary ammonium, sodium, potassium, lithium, magnesium, or calcium salt or combination of such salts.

In some aspects, the bubble modifier comprises at least one, at least 2, at least 3, or more compounds selected from the group consisting of 3-O-coumaroylquinic acid, 4-O-coumaroylquinic acid, 5-O-coumaroylquinic acid, 3,4-dicoumaroylquinic acid, 3,5-dicoumaroylquinic acid, and 4,5-dicoumaroylquinic acid.

Caffeic acid has the structure:

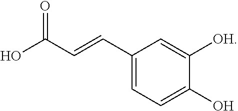 [SMILES: O=C(O)/C=C/c1ccc(O)c(O)c1]

Ferulic acid has the structure:

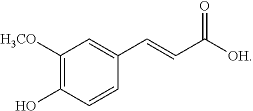 [SMILES: COc1cc(/C=C/C(=O)O)ccc1O]

p-Coumaric acid has the structure:

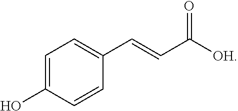 [SMILES: O=C(O)/C=C/c1ccc(O)cc1]

Sinapic acid has the structure:

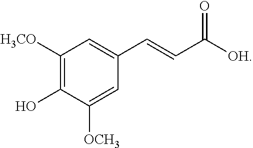 [SMILES: COc1cc(/C=C/C(=O)O)cc(OC)c1O]

Quinic acid has the structure:

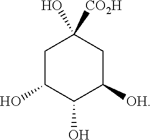 [SMILES: O=C(O)[C@]1(O)C[C@@H](O)[C@@H](O)[C@H](O)C1]

3-(3,4-dihydroxyphenyl)lactic acid has the structure:

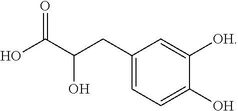 [SMILES: O=C(O)C(O)Cc1ccc(O)c(O)c1]

Tartaric acid has the structure:

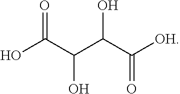

and can be in the D and L forms.

Examples of the esters of the various acids contemplated herein include the ester of caffeic acid and tartaric acid, which includes cichoric acid having the structure:

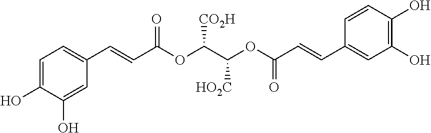 [SMILES: O=C(/C=C/c1ccc(O)c(O)c1)O[C@H](C(=O)O)[C@H](OC(=O)/C=C/c1ccc(O)c(O)c1)C(=O)O]

which has two caffeic acid molecules linked to a tartaric acid core; and caftaric acid having the structure:

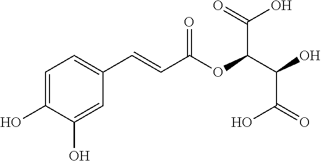 [SMILES: O=C(/C=C/c1ccc(O)c(O)c1)O[C@@H](C(=O)O)[C@@H](O)C(=O)O]

which has one caffeic acid molecule linked to a tartaric acid core.

Examples of the esters of the various acids contemplated herein also include the ester of caffeic acid and 3-(3,4-dihydroxyphenyl)lactic acid including, for example, rosmarinic acid, which has the structure:

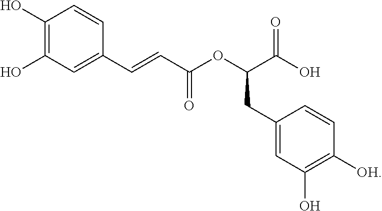 [SMILES: O=C(/C=C/c1ccc(O)c(O)c1)O[C@H](Cc1ccc(O)c(O)c1)C(=O)O]

Examples of the esters of the various acids contemplated herein include the ester of caffeic acid and quinic acid, which includes monocaffeoylquinic acids (e.g., chlorogenic acid, neochlorogenic acid, and cryptochlorogenic acid), and dicaffeoylquinic acids (e.g., 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, and 4,5-dicaffeoylquinic acid), and salts thereof:

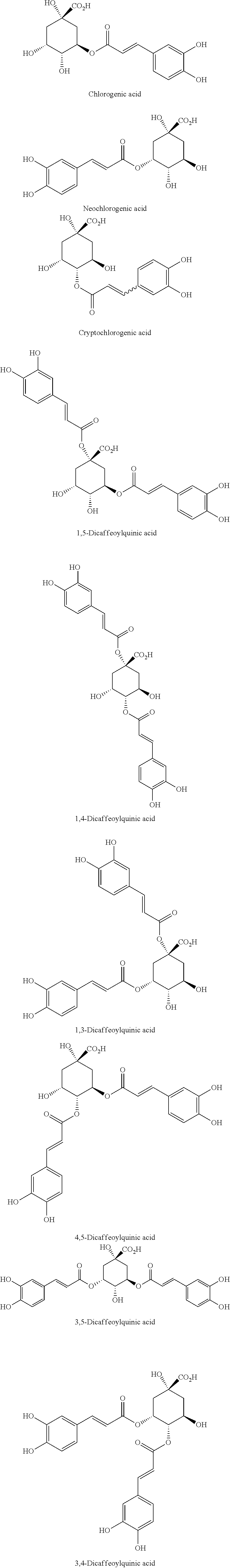

with 4,5-dicaffeoylquinic acid, 3,5-dicaffeoylquinic acid, and 3,4-dicaffeoylquinic acid being most prevalent in the compositions contemplated herein and prevalent in abundance in stevia, yerba mate, globe artichoke, and green coffee.

The caffeic acid, monocaffeoylquinic acids, dicaffeoylquinic acids and other bubble modifier compounds can be considered weak acids and can each exist in at least one of their conjugate acid form, conjugate base form (e.g., in their salt form), and mixed conjugate acid-conjugate base form, wherein a fraction (e.g., mole fraction) of the compounds exists in the conjugate acid form and another fraction exists in the conjugate base form. The fraction of conjugate acid form to conjugate base form for the caffeic acid, monocaffeoylquinic acids, dicaffeoylquinic acids, and other bubble modifier compounds will depend on various factors, including the pKa of each compound and the pH of the composition.

Examples of salts of caffeic acid, monocaffeoylquinic acids, dicaffeoylquinic acids, and other bubble modifier compounds include, but are not limited to, their quaternary ammonium, sodium, potassium, lithium, magnesium, and calcium salts or combination of such salts.

In some aspects, the bubble modifier can be enriched for one or more of caffeic acid, monocaffeoylquinic acids, and dicaffeoylquinic acids. The term “enriched” refers to an increase in an amount of one of caffeic acid, monocaffeoylquinic acids, and dicaffeoylquinic acids relative to one or more other compounds that are present in the bubble modifier. A bubble modifier that is enriched for one or more of caffeic acid, monocaffeoylquinic acids, and dicaffeoylquinic acids can enhance bubble modification, e.g., further reduce bubble size in a gaseous aqueous solution and/or modify foam properties of a modified steviol glycoside solution.

In some aspects, a bubble modifier enriched for one or more dicaffeoylquinic acids can comprise 10% or more, 15% or more, 20% or more, 25% or more, 30% or more, 35% or more, 40% or more, 45% or more, 50% or more, 60% or more, 70% or more, 80% or more, or 90% or more dicaffeoylquinic acids. In other aspects, a bubble modifier that is enriched for dicaffeoylquinic acids can comprise 10% or more, 15% or more, 20% or more, 25% or more, 30% or more, 35% or more, 40% or more, 45% or more, or 50% or more, 60% or more, 70% or more, or 80% or more, or 90% or more of a combination of one or more of 1,3-dicaffeoylquinic acid, 1,4-dicaffeoylquinic acid, 1,5-dicaffeoylquinic acid, 3,4-dicaffeoylquinic, 3,5-dicaffeoylquinic acid, and 4,5-dicaffeoylquinic acid, and salts thereof.

Certain preferred bubble modifiers specifically include a dicaffeoylquinic (DCQ) component and a monocaffeoylquinic (MCQ) component. The DCQ component includes at least one, desirably at least 2 or at least 3, dicaffeoylquinic acids or salts thereof. In one aspect, the DCQ component includes at least one compound selected from the group consisting of 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, 4,5-dicaffeoylquinic acid, and salts thereof. The MCQ component includes at least one, desirably at least 2 or at least 3, monocaffeoylquinic acids or salts thereof. In one aspect, the MCQ component includes at least one compound selected from the group consisting of chlorogenic acid, cryptochlorogenic acid, neochlorogenic acid, and salts thereof.

The DCQ component and the MCQ component may together comprise more than 50 percent by weight (“% (wt)” or “wt %”) of the bubble modifier. Desirably, the DCQ component and the MCQ component together comprise more than 60% (wt), more than 70% (wt), more than 80% (wt), more than 90% (wt), more than 95% (wt), or more than 98% (wt) of the bubble modifier.

The bubble modifier may include bubble modifier compounds in addition to the MCQ and DCQ components. One useful bubble modifier includes the MCQ component, the DCQ component, and one or more compounds selected from the group consisting of caffeic acid, ferulic acid, p-coumaric acid, sinapic acid, quinic acid, 3-(3,4-dihydroxyphenyl)lactic acid, tartaric acid, chicoric acid, caftaric acid, monoferuloylquinic acids, diferuloylquinic acids, monocoumaroylquinic acids, dicoumaroylquinic acids, and salts thereof. In certain aspects, such a bubble modifier includes the MCQ component, the DCQ component, and one or more compounds selected from the group consisting of caffeic acid, monoferuloylquinic acids, diferuloylquinic acids, and salts thereof. In one implementation, the MCQ component, the DCQ component, and one or more compounds selected from that group together comprise more than 70% (wt), more than 75% (wt), more than 80% (wt), more than 90% (wt), more than 95% (wt), or more than 98% (wt) of the bubble modifier.

A weight ratio of the DCQ component to the MCQ component may be at least 0.2, at least 0.33, or at least 0.5. Preferably, this ratio is at least 1, at least 2, at least 3, at least 4, at least 5, at least 6, at least 7, at least 8, at least 9, or at least 10. In certain aspects, this ratio is no more than 20 or no more than 10, e.g., between 1 and 20, preferably between 1 and 10, between 2 and 10, between 3 and 10, between 4 and 10, or between 5 and 10. Depending on the botanical source, getting increasingly higher ratios of the DCQ component to the MCQ component may increase processing cost to obtain the bubble modifier without adversely impacting a commercially relevant use, e.g., in a beverage having less than 1,000 ppm of steviol glycoside.

Certain commercially useful bubble modifiers have a weight ratio of the DCQ component to the MCQ component of between 0.33 and 5. Such compositions were found to produce non-alcoholic beverages with particularly desirable sensory properties. Thus, in some aspects the weight ratio of the DCQ component to the MCQ component in the bubble modifier is between 0.33 and 5, between 0.5 and 5, between 1 and 5, between 1.5 and 5, between 2 and 5, between 3 and 5, between 0.5 and 4, between 1 and 4, between 1.5 and 4, between 0.5 and 3, between 1 and 3, or between 1.5 and 3.

One suitable bubble modifier has a weight ratio of the DCQ component to the MCQ component of at least 1, preferably at least 2, at least 3, or at least 4 and the DCQ component and MCQ component together comprise more than 70% (wt), e.g., more than 80% (wt) or more than 90% (wt), of the bubble modifier.

Bubble modifiers, or bubble modifier compounds for use in bubble modifiers, may be isolated in a variety of ways. Some suitable processes are disclosed in more detail in U.S. Provisional Application Ser. No. 62/676,722, filed May 25, 2018, and entitled “Methods for Making Yerba Mate Extract Composition.” For example, bubble modifier or bubble modifier compounds for use in bubble modifiers may be isolated from a botanical source that comprises one or more of monocaffeoylquinic acid, dicaffeoylquinic acid, and salts thereof. For example, yerba mate biomass and stevia biomass can be used to prepare suitable bubble modifiers. In one exemplary process, a bubble modifier is prepared from commercially obtained comminuted yerba mate biomass. Briefly, yerba mate biomass is suspended in 50% (v/v) ethanol/water, shaken for at least 1 hour, and the resulting mixture filtered to obtain an initial extract. The initial extract is diluted to 35% (v/v) ethanol with water and refiltered. Refiltered permeate is then applied to a column of AMBERLITE® FPA 53 resin that has been equilibrated in 35% (v/v) ethanol/water and the column permeate is discarded. The column is washed with 35% (v/v) ethanol/water and the column permeate is discarded. The column is then eluted with 10% (w/v) FCC grade sodium chloride in 50% (v/v) ethanol/water and the eluent retained. Nitrogen gas is blown at room temperature over a surface of the eluent to remove ethanol and reduce the eluent to ⅓ of its original volume. The reduced volume eluent is then filtered through a 0.2 μm polyethersulfone filter and then decolored by passing through a 3 kDa molecular weight cutoff membrane. The decolored permeate is retained and desalted by passing through a nanofiltration membrane. The desalted permeate is then freeze-dried to obtain the bubble modifier, or a composition of bubble modifier compounds that can be used in a bubble modifier. This process is also suitable to obtain bubble modifier or bubble modifier compounds for use in bubble modifiers, from stevia biomass and can be adapted to obtain bubble modifier or bubble modifier compounds from other botanical sources.

In some aspects, the bubble modifier, or bubble modifier compounds for use in bubble modifiers, may be isolated from botanical sources. Some examples of botanical sources from which bubble modifiers or bubble modifier compounds can be isolated include eucommoia ulmoides, honeysuckle, Nicotiana benthamiana, globe artichoke, cardoon, stevia, Stevia rebaudiana, monkfruit, coffee, coffee beans, green coffee beans, tea, white tea, yellow tea, green tea, oolong tea, black tea, red tea, post-fermented tea, bamboo, heather, sunflower, blueberries, cranberries, bilberries, grouseberries, whortleberry, lingonberry, cowberry, huckleberry, grapes, chicory, eastern purple coneflower, echinacea, Eastern pellitory-of-the-wall, Upright pellitory, Lichwort, Greater celandine, Tetterwort, Nipplewort, Swallowwort, Bloodroot, Common nettle, Stinging nettle, Potato, Potato leaves, Eggplant, Aubergine, Tomato, Cherry tomato, Bitter apple, Thorn apple, Sweet potato, apple, Peach, Nectarine, Cherry, Sour cherry, Wild cherry, Apricot, Almond, Plum, Prune, Holly, Yerba mate, Mate, Ilex paraguariensis, Guayusa, Yaupon Holly, Kuding, Guarana, Cocoa, Cocoa bean, Cacao, Cacao bean, Kola nut, Kola tree, Cola nut, Cola tree, Hornwort, Ostrich fern, Oriental ostrich fern, Fiddlehead fern, Shuttlecock fern, Oriental ostrich fern, Asian royal fern, Royal fern, Bracken, Brake, Common bracken, Eagle fern, Eastern brakenfern, dandelion, algae, seagrasses, Clove, Cinnamon, Indian bay leaf, Nutmeg, Bay laurel, Bay leaf, Basil, Great basil, Saint-Joseph's-wort, Thyme, Sage, Garden sage, Common sage, Culinary sage, Rosemary, Oregano, Wild marjoram, Marjoram, Sweet marjoram, Knotted marjoram, Pot marjoram, Dill, Anise, Star anise, Fennel, Florence fennel, Tarragon, Estragon, Mugwort, Licorice, Liquorice, Soy, Soybean, Soyabean, Soya vean, Wheat, Common wheat, Rice, Canola, Broccoli, Cauliflower, Cabbage, Bok choy, Kale, Collard greens, Brussels sprouts, Kohlrabi, Winter's bark, Elderflower, Assa-Peixe, Greater burdock, Valerian, and Chamomile. In some aspects, the botanical source is yerba mate, chicory, rosemary, globe artichoke, cardoon, and/or stevia.

In some aspects, the bubble modifier can be a blend of bubble modifier compounds isolated from more than one botanical source. It may instead be a blend of bubble modifier compounds isolated from more than one botanical source and/or a synthesized or fermented hydroxycinnamic acid.

Some plants may produce bubble modifiers that are enriched for one or more of caffeic acid, monocaffeoylquinic acids, and dicaffeoylquinic acids. For example, bubble modifiers isolated from yerba mate plant (Ilex paraguariensis) and some other plants are naturally enriched for dicaffeoylquinic acids.

Some compounds can adversely impact flavor or aroma of a gaseous aqueous solution or a modified steviol glycoside solution. Certain bubble modifiers, such as those prepared from a plant extract do not include one or more of the compounds shown in Table 1, or any combination thereof, above the disclosed preferred content levels. All preferred content levels are stated as weight percentage on a dry weight basis. Certain commercially desirable solid (dry) bubble modifiers do not include more than the preferred content level of the list of compounds listed in Table 1.

TABLE 1

| Class of | Preferred Content | % wt of compounds in solid (dry) bubble |
|---|---|---|
| compounds | Level (% wt) | modifiers |
| Organic acids | <3%, preferably <2%, | malonate, malonic acid, oxalate, oxalic acid, |
| | <1%, or 0% | lactate, lactic acid, succinate, succinic acid, malate, |
| | | malic acid, citrate, citric acid |
| | <0.5%, preferably | tartrate, tartaric acid, pyruvate, pyruvic acid, |
| | <0.25% or 0% | fumarate, fumaric acid, ascorbic acid, sorbate, |
| | | sorbic acid, acetate, acetic acid |
| Inorganic acids | <1%, preferably | sulfate, sulfuric acid, phosphate, phosphoric acid, |
| | <0.5% or 0% | nitrate, nitric acid, nitrite, nitrous acid, chloride, |
| | | hydrochloric acid, ammonia, ammonium |
| Flavanoids, | <5%, preferably <4%, | quercetin, kaempferol, myricetin, fisetin, galangin, |
| isoflavanoids, and | <3%, or <2%, more | isorhamnetin, pachypodol, rhamnazin, |
| neoflavanoids | preferably <1%, | pyranoflavonols, furanoflavonols, luteolin, |
| | <0.5%, or 0% | apigenin, tangeritin, taxifolin (or dihydroquercetin), |
| | | dihydrokaempferol, hesperetin, naringenin, |
| | | eriodictyol, homoeriodictyol, genistein, daidzein, |
| | | glycitein |
| Flavanoid | <5%, preferably <4%, | hesperidin, naringin, rutin, quercitrin, luteolin- |
| glycosides | <3%, or <2%, more | glucoside, quercetin-xyloside |
| | preferably <1%, | |
| | <0.5%, or 0% | |
| Anthocyanidins | <5%, preferably <4%, | cyanidin, delphinidin, malvidin, pelargonidin, |
| | <3%, or <2%, more | peonidin, petunidin |
| | preferably <1%, | |
| | <0.5%, or 0% | |
| Tannins | <1%, preferably | tannic acid |
| | <0.5%, <0.25%, or 0% | |
| Amino acids + | <0.1%, preferably | alanine, arginine, asparagine, aspartic acid, |
| total protein | <0.05%, or 0% | cysteine, glutamine, glutamic acid, glycine, |
| | | histidine, isoleucine, leucine, lysine, methionine, |
| | | phenylalanine, proline, serine, threonine, |
| | | tryptophan, tyrosine, and valine |
| Total Fat | <1%, preferably | monoglycerides, diglycerides, triglycerides |
| | <0.5%, <0.25%, or 0% | |
| Monosaccharides, | <1% | glucose, fructose, sucrose, galactose, ribose, |
| disaccharides, and | | trehalose, trehalulose, lactose, maltose, isomaltose, |
| polysaccharides | | isomaltulose, mannose, tagatose, arabinose, |
| | | rhamnose, xylose, dextrose, erythrose, threose, |
| | | maltotriose, panose |
| Sugar alcohols | <1% | glycerol, sorbitol, mannitol, xylitol, maltitol, |
| | | lactitol, erythritol, isomalt, inositol |
| Dietary fiber | <0.1%, preferably | acacia (arabic) gum, agar-agar, algin-alginate, |
| | <0.05% or 0% | arabynoxylan, beta-glucan, beta mannan, |
| | | carageenan gum, carob or locust bean gum, |
| | | fenugreek gum, galactomannans, gellan gum, |
| | | glucomannan or konjac gum, guar gum, |
| | | hemicellulose, inulin, karaya gum, pectin, |
| | | polydextrose, psyllium husk mucilage, resistant |
| | | starches, tara gum, tragacanth gum, xanthan gum, |
| | | cellulose, chitin, and chitosan |
| Steviol glycoside | <55% | stevioside; steviolbioside; rubusoside; 13- and 19- |
| compounds | | SMG; dulcosides A, B, C, D; and rebaudiosides A, |
| | | B, C, D, E, F, I, M, N, O, T |
| Saponins | <0.5%, preferably | glycosylated ursolic acid and glycosylated oleanolic |
| | <0.25% or 0% | acid |
| Terpenes other | <0.5%, preferably | eugenol, geraniol, geranial, alpha-ionone, beta- |
| than saponins and | <0.25% or 0% | ionone, epoxy-ionone, limonene, linalool, linalool |
| steviol glycoside | | oxide, nerol, damascenone |
| compounds | | |
| Lipid oxidation | <0.5%, preferably | Decanone, decenal, nonenal, octenal, heptenal, |
| products | <0.25% or 0% | hexenal, pentenal, pentenol, pentenone, hexenone, |
| | | hydroxynonenal, malondialdehyde |
| Polycyclic | <0.1%, preferably | Acenaphthene, Acenaphthylene, Anthracene, |
| Aromatic | <0.05% or 0% | Benzo(a)anthracene, Benzo(a)pyrene, |
| Hydrocarbons | | Benzo(b)fluoranthene, Benzo(ghi)perylene, |
| | | Benzo(k)fluoranthene, Chrysene, |
| | | Dibenzo(a,h)anthracene, Fluoranthene, Fluorene, |
| | | Indeno(1,2,3-cd)pyrene, Naphthalene, Phenanthrene, |
| | | Pyrene |
| Other compounds | <0.1%, preferably | chlorophyll, furans, furan-containing chemicals, |
| | <0.05% or 0% | theobromine, theophylline, and trigonelline |

One suitable bubble modifier, which may be particularly useful in unsweetened gaseous aqueous solutions, includes <10% (wt), <5% (wt), <4% (wt), <3% (wt), <2% (wt), <1% (wt), <0.5% (wt), <0.25% (wt), <0.10% (wt) or 0% (wt), steviol glycoside compounds. In select implementations, such a bubble modifier is substantially free of steviol glycoside compounds. Particularly where the bubble modifier is derived from stevia, e.g., stevia leaves, reducing the amount of steviol glycoside compounds, or not including steviol glycoside compounds, in the bubble modifier allows more precise selection of the steviol glycoside compounds or other sweeteners to achieve a desired flavor profile of a modified steviol glycoside solution.

As noted above, some compounds can adversely impact flavor or aroma of a gaseous aqueous solution or a modified steviol glycoside solution. One useful bubble modifier includes an MCQ component, a DCQ component, and less than 0.3% (wt), e.g., 0% of malonate, malonic acid, oxalate, oxalic acid, lactate, lactic acid, succinate, succinic acid, malate, or malic acid; or less than 0.05% (wt), e.g., 0% of pyruvate, pyruvic acid, fumarate, fumaric acid, tartrate, tartaric acid, sorbate, sorbic acid, acetate, or acetic acid; or less than about 0.05% (wt), e.g., 0% of chlorophyll. In one aspect, the bubble modifier is free of malonate, malonic acid, oxalate, oxalic acid, lactate, lactic acid, succinate, succinic acid, malate, and malic acid; or is free of pyruvate, pyruvic acid, fumarate, fumaric acid, tartrate, tartaric acid, sorbate, sorbic acid, acetate, and acetic acid; or is chlorophyll-free.

### Steviol Glycosides

Aqueous solutions in keeping with aspects of the disclosure can include one or more steviol glycoside compounds and one or more bubble modifier compounds, as well as other compounds. Steviol glycoside compounds generally have the formula

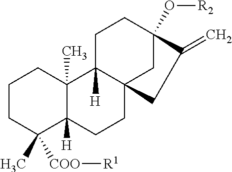

wherein steviol (R₁ and R₂=H) is the aglycone backbone and R₁ and R₂ can each be hydrogen or one or more sugar moieties. These sugar moieties are most commonly glucose, rhamnose, or xylitol, but steviol glycoside compounds have been reported that include fructose and deoxyglucose sugar moieties.

Exemplary steviol glycoside compounds that may be useful in solutions described herein include one or more of Rebaudioside A (Reb A) (CAS #58543-16-1), Rebaudioside B (Reb B) (CAS #58543-17-2), Rebaudioside C (Reb C) (CAS #63550-99-2), Rebaudioside D (Reb D) (CAS #63279-13-0), Rebaudioside E (Reb E) (CAS #63279-14-1), Rebaudioside F (Reb F) (CAS #438045-89-7), Rebaudioside M (Reb M) (CAS #1220616-44-3), Rubusoside (CAS #63849-39-4), Dulcoside A (CAS #64432-06-0), Rebaudioside I (Reb I) (MassBank Record: FU000332), Rebaudioside Q (Reb Q), Rebaudioside O (Reb O), Rebaudioside N (Reb N) (CAS #1220616-46-5), 1,2-Stevioside (CAS #57817-89-7), 1,3-Stevioside (Reb G), Steviol-1,2-Bioside (MassBank Record: FU000299), Steviol-1,3-Bioside, Steviol-13-O-glucoside (13-SMG), Steviol-19-O-glucoside (19-SMG), and steviol glycoside compounds having 1, 2, 3, 4, 5, 6, 7, 8, 9, 10 or sugar additions (e.g., glucose, rhamnose, and/or xylose), and isomers thereof. See, e.g., Steviol Glycosides Chemical and Technical Assessment 82nd JECFA, 2016, revised by Jeff Moore, Food Agric. Org.

Exemplary steviol glycosides can include rebaudioside M, rebaudioside D, rebaudioside A, rebaudioside B, and/or rebaudioside N. In some aspects, one or more of the steviol glycoside compounds are produced by fermentation by an engineered microorganism. In some aspects, one or more of the steviol glycoside compounds are produced by bioconversion by an enzyme and leaf extract. For example, rebaudioside D and M can be produced by an engineered organism and then isolated to produce a steviol glycoside composition of primarily rebaudioside D and rebaudioside M as the predominant steviol glycoside compound species. In some aspects, one or more of the steviol glycoside compounds are isolated from Stevia rebaudiana.

In some aspects, the steviol glycoside can comprise rebaudioside D and rebaudioside M in an amount greater than other steviol glycoside compounds. For example, rebaudioside M and/or rebaudioside D can be present in the steviol glycoside in a total amount of about 75% (wt) or greater, about 80% (wt) or greater, about 80% (wt) or greater, preferably about 90% (wt) or greater, about 92.5% (wt) or greater, or 95% (wt) or greater, of a total amount of steviol glycoside compounds in the composition. Rebaudioside M can be the predominant steviol glycoside compound in the steviol glycoside, and can be present, for example, in an amount in the range of about 45% (wt) to about 70% (wt), about 50% (wt) to about 65% (wt), or about 52.5% (wt) to about 62.5% (wt) of the total amount of steviol glycoside compounds in the composition. Rebaudioside D can be in an amount less than Rebaudioside M, such as in an amount in the range of about 25% (wt) to about 50% (wt), about 30% (wt) to about 45% (wt), or about 32.5% (wt) to about 42.5% (wt) of the total amount steviol glycoside compounds in the composition.

The steviol glycoside can optionally include lesser amounts of steviol glycoside compounds other than rebaudioside D and rebaudioside M. For example, the composition can include one or more of rebaudioside A, rebaudioside B, or stevioside in an amount of about 1% (wt) or less, about 0.5% (wt) or less, or about 0.25% (wt) or less, of a total amount steviol glycoside compounds in the composition.

### Modified Steviol Glycoside Solutions

The amount of steviol glycoside in a modified steviol glycoside solution can vary depending on desired use. For example, steviol glycoside can be present in a modified steviol glycoside solution at a concentration at least 20 ppm, preferably at least 50 ppm, e.g., from about 50 ppm to about 1000 ppm, from about 50 ppm to about 10000 ppm (1% (wt)), from about 50 ppm to about 100000 ppm (10% (wt)), from about 50 ppm to about 200000 ppm (20% (wt)), or from about 50 ppm to about 300000 ppm (30% (wt)). In some aspects, the steviol glycoside is present at a concentration at least 10, 100, 200, 300, 400, 500, 600, 700, 800, 900, or 1000 ppm.

In certain modified steviol glycoside solutions, steviol glycoside is present at a level that can function as a flavor, e.g., as a sweetness enhancer, but below a level at which one would detect sweetness. Such modified steviol glycoside solutions may have a steviol glycoside concentration of about 10-80 ppm, about 10-65 ppm, about 10-50 ppm, about 10-40 ppm, about 15-65 ppm, about 15-50 ppm, about 15-40 ppm, or about 20-30 ppm. Specific examples of modified steviol glycoside solutions in which steviol glycoside is present at flavor levels include 15-80 ppm, e.g., 16-65 ppm, total of rebaudioside M and rebaudioside A or about 20-24 ppm rebaudioside M.

Other modified steviol glycoside solutions may have higher steviol glycoside concentrations that may provide a perceptible sweetness, e.g., from about 100 ppm to about 5000 ppm, about 200 ppm to about 5000 ppm, 300 ppm to about 5000 ppm, 400 ppm to about 5000 ppm, 500 ppm to about 5000 ppm, 600 ppm to about 5000 ppm, 700 ppm to about 5000 ppm, 800 ppm to about 5000 ppm, 900 ppm to about 5000 ppm, or 1000 ppm to about 5000 ppm. In other aspects, the steviol glycoside is present at a concentration from about 1000 ppm to about 5000 ppm, about 2000 ppm to about 5000 ppm, about 3000 ppm to about 5000 ppm, or about 4000 ppm to about 5000 ppm. Steviol glycoside can be present in the modified steviol glycoside solution at a concentration of or greater than about 10, 100, 200, 300, 400, 500, 600, 700, 800, 900, 1000, 2000, 3000, 4000, 5000, 6000, 7000, 8000, 9000, 10000, 20000, 30000, 40000, 50000, 60000, 70000, 80000, 90000, 100000, 200000, or 300000 ppm.

In another aspect, the steviol glycoside is present in the modified steviol glycoside solution at a concentration in the range of about 10 ppm to about 1,000 ppm, more specifically about 10 ppm to about 800 ppm, about 50 ppm to about 800 ppm, about 50 ppm to about 600 ppm, or about 200 ppm to about 500 ppm. In certain commercially useful implementations, e.g., in a ready-to-drink beverage, the steviol glycoside concentration in the modified steviol glycoside solution may be 100 ppm to 1600 ppm, preferably 200 ppm to 1000 ppm, or more preferably 400 ppm to 800 ppm.

The modified steviol glycoside solution may have any suitable pH, e.g., between 0 and 7, between 1 and 6, or between 1.5 and 4.

The amount of bubble modifier in the modified steviol glycoside solution can vary depending on the desired use. For example, bubble modifier can be present in the modified steviol glycoside solution at from about 1 ppm to about 1000 ppm, from about 1 ppm to about 10000 ppm, from about 1 ppm to about 100000 ppm, from about 1 ppm to about 200000 ppm, or from about 1 ppm to about 300000 ppm. In some aspects, bubble modifier can be present in the modified steviol glycoside solution at about 100 ppm to about 5000 ppm, about 200 ppm to about 5000 ppm, 300 ppm to about 5000 ppm, 400 ppm to about 5000 ppm, 500 ppm to about 5000 ppm, 600 ppm to about 5000 ppm, 700 ppm to about 5000 ppm, 800 ppm to about 5000 ppm, 900 ppm to about 5000 ppm, or 1000 ppm to about 5000 ppm. In some aspects, bubble modifier can be present in the modified steviol glycoside solution at from about 1000 ppm to about 5000 ppm, about 2000 ppm to about 5000 ppm, about 3000 ppm to about 5000 ppm, or about 4000 ppm to about 5000 ppm. In some aspects, bubble modifier can be present in the modified steviol glycoside solution at or greater than about 10, 100, 200, 300, 400, 500, 600, 700, 800, 900, 1000, 2000, 3000, 4000, 5000, 6000, 7000, 8000, 9000, 10000, 20000, 30000, 40000, 50000, 60000, 70000, 80000, 90000, or 100000 ppm. In some aspects, bubble modifier can be present in the modified steviol glycoside solution at or greater than about 200000 ppm. In some aspects, bubble modifier can be present in the modified steviol glycoside solution at or greater than about 300000 ppm.

In an aqueous solution, be it a modified steviol glycoside solution or a gaseous aqueous solution, bubble modifier compounds may be present in acid form or in a salt form, e.g., as a quaternary ammonium, sodium, potassium, lithium, magnesium, or calcium salt or combination of such salts. In an aqueous solution, the bubble modifier may be dissociated or undissociated, e.g., part or all of a potassium salt of an acid bubble modifier compound may be dissociated into a potassium cation and an anion.

The ratio of bubble modifier to steviol glycoside in the modified steviol glycoside solution can vary. The ratio of bubble modifier to steviol glycoside in the modified steviol glycoside solution can be varied as desired or needed to make it effective to reduce bubble size in the liquid matrix of the modified steviol glycoside solution or to improve foaming characteristics of the modified steviol glycoside solution. For example, the ratio of bubble modifier to steviol glycoside can be from about 0.1 to 10. In some aspects, the ratio of bubble modifier to steviol glycoside can be between about 0.1 and 5, between about 0.5 and 4, or between about 1 and 3.

In some aspects, the modified steviol glycoside solution comprises primarily water. The modified steviol glycoside solution can also be buffered with any suitable buffering system, including, but not limited to, one or more buffers such as a phosphate, a citrate, ascorbate, lactate, acetate, and the like. The buffer can comprise 1-1000 mM of the anion component. In other aspects, the modified steviol glycoside solution comprises a citrate/phosphate buffer. In some aspects, citrate/phosphate buffer can have a pH of 2 to 4.

In some aspects, the modified steviol glycoside solution can comprise additives, flavors, colors, fillers, bulking agents, and other ingredients. A wide variety of such ingredients are known for various applications.

In one aspect, the modified steviol glycoside solution is a beverage product comprising steviol glycoside and bubble modifier. As used herein a “beverage product” is a ready-to-drink beverage, a beverage concentrate, a beverage syrup, frozen beverage, or a powdered beverage. Suitable ready-to-drink beverages include gasified and non-gasified beverages. Gasified beverages include, but are not limited to, carbonated and nitrogenated beverages such as enhanced sparkling beverages, cola, flavored sparkling beverages such as lemon-lime flavored and orange flavored sparkling beverages, ginger-ale, soft drinks, root beer, cream soda, and enhanced sparkling beverages. Non-carbonated beverages include, but are not limited to fruit juice, fruit-flavored juice, juice drinks, nectars, vegetable juice, vegetable-flavored juice, sports drinks, energy drinks, enhanced water drinks, enhanced water with vitamins, near water drinks (e.g., water with natural or synthetic flavorants), coconut water, tea type drinks (e.g. black tea, green tea, red tea, oolong tea), coffee, cocoa drink, beverage containing milk components (e.g. milk beverages, coffee containing milk components, cafe au lait, milk tea, fruit milk beverages), beverages containing cereal extracts, smoothies and combinations thereof.

Beverage concentrates and beverage syrups can be prepared with an initial volume of liquid matrix (e.g. water) and the desired beverage ingredients. Full strength beverages are then prepared by adding further volumes of water.

In some aspects, a beverage concentrate may be used as a throw syrup for preparing a gaseous aqueous solution, such as a carbonated soda drink prepared in a soda fountain. The modified steviol glycoside solution can comprise primarily water, but may also include alcohol.

The modified steviol glycoside solution can also comprise a buffer such as a citrate/phosphate buffer. The citrate/phosphate buffer can have a pH of 1.5 to 4, e.g., 2-4.

In some aspects, the beverage concentrate solution is diluted before use as a beverage, e.g., in a soda fountain by diluting it with a stream of gasified water as the beverage is dispensed to form a gaseous aqueous solution. The volume of the final diluted beverage may be much larger than the concentrate, e.g., 5 to 7 times (in the case of a typical throw syrup) or 80-100 times (in the case of a typical liquid enhancer) the volume of the beverage concentrate solution in that beverage. The bubble modifier can be present in the beverage concentrate in an amount effective to improve foaming properties as the beverage is dispensed. Such a beverage concentrate useful as a throw syrup may have about 1500 to 4200 ppm of steviol glycoside and 1800 to 5400 ppm, e.g., 1800-3000 ppm, of bubble modifier. If the beverage concentrate will be used as a liquid enhancer that is diluted 80-100 times in the final beverage, it may have about 4800 to 20,000 ppm, e.g., 6000-10,000 ppm, of steviol glycoside and 2400 to 20,000 ppm, e.g., 3000-10,000 ppm, of bubble modifier.

Modified steviol glycoside solutions may be non-alcoholic or alcoholic. A non-alcoholic modified steviol glycoside solution, e.g., a non-alcoholic beer, may contain less than 0.5% (wt), preferably less than 0.2% (wt), less than 0.1% (wt), or less than 0.05% (wt), e.g., 0% (wt) of ethanol. Alcoholic modified steviol glycoside solutions may contain more than 0.5% (wt) alcohol, e.g., 2-60% (wt). Some bubble modifier compounds may not be very soluble in alcohol, though. An alcoholic modified steviol glycoside solution may have the bubble modifier up to a solubility limit of some or all of its constituent bubble modifier compounds. In order to maintain some useful bubble modifiers in solution, the alcohol content of an alcoholic modified steviol glycoside solution may be kept at a relatively low level 1-5% (wt) alcohol.

Bubble modifiers in aqueous solutions without steviol glycoside compounds do not have a very large impact on the foaming behavior of such aqueous solutions. Steviol glycoside compounds in aqueous solutions without bubble modifiers do impact the foaming behavior of such aqueous solutions. We have discovered, though, that modified solutions that include steviol glycoside, e.g., sweetening levels of steviol glycoside compounds, and bubble modifiers described herein have a dramatic impact on foaming behavior.

Such modified steviol glycoside solutions with modified foam properties may form more foam, a more stable foam, and/or a foam with reduced bubble size. This can be commercially attractive in a variety of applications. For example, a greater foam volume and/or a more stable foam may be particularly visually appealing for carbonated beverages such as root beer; beer, which is typically gasified with carbon dioxide or, increasingly, nitrogen or combinations of carbon dioxide and nitrogen; and to give non-alcoholic beer more of a “head” so they look more like conventional beer.

In one aspect, modified steviol glycoside solutions in accordance with the disclosure have at least 20 ppm, preferably at least 50 ppm, or at least 100 ppm of steviol glycoside and bubble modifier at a concentration of 50 ppm to 1600 ppm. The concentration of the bubble modifier in the modified steviol glycoside solution should be effective to reduce a mean bubble diameter in the foam compared to the aqueous solution without the bubble modifier. The foam may be natively formed by effervescence of gas dissolved in the modified steviol glycoside solution if it is a gasified aqueous solution. The foam may form in other ways, either alone or in addition to effervescence. For example, the foam may be formed by mixing the modified steviol glycoside solution with carbonated water in a soda fountain, by agitation, e.g., mixing in a blender or shaking, or by bubbling a gas through the modified steviol glycoside solution.

A standardized test protocol to determine whether a modified steviol glycoside solution has an amount of bubble modifier effective to modify a foam in a desired fashion (e.g., by reducing the size of bubbles in the foam by at least 5%) is referred to herein as the Foamscan test. This test is conducted on a Foamscan instrument commercially available from Teclis Scientific. The Foamscan analyzes foam behavior by injecting or “sparging” gas through a volume of liquid and measuring the volume of foam generated by the sparged gas, the stability of that foam, and/or visually characterizing the foam. The Foamscan is run by delivering air for 60 seconds to 60 ml of the modified steviol glycoside solution at an airflow rate of 150 ml/minute. The temperature of the modified steviol glycoside solution should be 15.6° C. (60° F.) and the test should be conducted at an ambient pressure of 1 atmosphere.

As explained in Example 1 below, the Foamscan instrument running the Foamscan test can determine the mean area of bubbles in the foam by taking a digital picture of the foam and analyzing the image. The picture is two-dimensional, so the bubble size is measured as the area of the bubble in the picture. To determine the mean diameter of the bubbles, the bubbles may be assumed to approximate a sphere, which would be reflected as a circle in two dimensions. The diameter can be readily derived from the area of the bubble in the picture:

$$diameter = 2 \sqrt{\frac{area}{π}}$$

One useful modified steviol glycoside solution has an amount of the bubble modifier that is effective, in the presence of the steviol glycoside, to reduce the mean bubble diameter in the foam compared to foam bubbles in a control aqueous solution without the bubble modifier (i.e., an aqueous solution having the same composition but for omission of the bubble modifier). The mean bubble diameter in the Foamscan test is desirably at least 5%, at least 10%, or at least 15%, preferably at least 20%, at least 25%, at least 30%, at least 40%, or at least 50% smaller in the modified steviol glycoside solution than the mean bubble diameter in the control solution.

The Foamscan instrument an also determine foam capacity (FC), foam maximum density (MD), foam expansion (FE), foam capacity (FC), and volumetric stability of the foam (t_{foam1/2}). Example 1 defines each of these measurements.

Modified steviol glycoside solutions suitable for certain commercial applications may have a foam capacity (defined below) of at least 0.8, determined using the maximum foam volume achieved in the sample run. Alternatively, the foam capacity can be determined using volumes measured at 30 seconds after the gas delivery was terminated (referred to as FC₃₀). Some such solutions may have a foam capacity or FC₃₀ of at least 0.9, at least 1.0, at least 1.1, or at least 1.2.

Viewed in another way, modified steviol glycoside solutions in accordance with aspects of this disclosure may have a foam capacity or FC₃₀ at least 40%, preferably at least 60%, at least 70%, at least 75%, or at least 80% greater than the foam capacity or FC₃₀, respectively, of a control aqueous solution without the bubble modifier.

The Foamscan test does not directly characterize the foam that may form on a solution in use, e.g., when dispensing a carbonated cola from a soda fountain or mixing a frozen beverage in a blender. Nonetheless, it is believed to provide valuable quantitative insight into the foaming characteristic of a beverage than can generally correlate to real-world foaming behavior in use.

As discussed in the Examples below, still beverages with varying compositions were analyzed using the Foamscan test, including flavored and unflavored still water. Still water samples were prepared with steviol glycoside and bubble modifier (SG+BM), with steviol glycoside but without the bubble modifier (SG), and with bubble modifier but without steviol glycoside (BM). The average final foam volumes (V_{foam}) were 82 for the SG samples, only 19 for the BM samples, but 161 for the SG+BM samples. That demonstrates a significant, unexpected synergy between the bubble modifier and the steviol glycoside. In certain aspects, the V_{foam} in a modified steviol glycoside solution as measured using the Foamscan test is at least 20% higher, at least 25% higher, or at least 30% higher, preferably at least 40% higher, at least 50% higher, or a least 60% higher than the V_{foam} for a first control solution having the same composition without the bubble modifier, than the V_{foam} for a second control solution having the same composition without the steviol glycoside, or than the V_{foam} for of both the first and second controls.

### Gasified Aqueous Solutions

Other aspects of the disclosure provide gasified aqueous solutions that include a bubble modifier, but may or may not include steviol glycoside. Examples of gaseous aqueous solutions without steviol glycoside include flavored carbonated waters and conventional ready-to-drink sodas, such as a cola or energy drink, sweetened with sugar, aspartame, or other non-steviol glycoside sweetener.

Gaseous aqueous solutions may be gasified with any gas suitable for the intended purpose. Beverages, for example, are conventionally gasified with carbon dioxide and/or nitrogen.

The amount of gas dissolved in the gaseous aqueous solution can vary widely, but should be sufficient for the gaseous aqueous solution to effervesce at STP. The gas in the modified steviol glycoside solution may be at a level at least 50%, preferably at least 100%, at least 200%, or at least 300%, higher than an equilibrium saturation value of the gas at STP. Nitrogen has limited solubility in most aqueous solutions. Accordingly, it may be desirable to include nitrogen and carbon dioxide, e.g., with nitrogen at its maximum solubility and the balance of the desired fizziness coming from CO₂.

The bubble modifier may be present in an amount effective to reduce the mean diameter of bubbles in the matrix of the modified steviol glycoside solution, or coalesced on a surface of the container for the modified steviol glycoside solution, relative to a control solution without the bubble modifier (i.e., an aqueous solution having the same composition but for omission of the bubble modifier). In one aspect, “in the matrix” is intended to indicate bubbles within the body of the solution rather than in a foam carried by the solution.

The mean bubble size may reduced for a long time or even until one of the modified steviol glycoside solution and the control solution no longer effervesces. Comparison of bubble diameter at a fixed time, however, may allow more reproducible results. This, in one aspect the bubble sizes in the modified steviol glycoside solution and the control are measured at STP within 1 minute of an onset of effervescence. It may be difficult if not impossible to measure bubble size in a can or bottle. Thus, a gasified canned or bottled beverage may be poured into a container more suitable for measuring bubble size and the onset of effervescence will be set as the time that the beverage is poured into the container. Some gaseous aqueous solutions may be formed by injecting the gas into the solution, e.g., by injecting nitrogen with a restriction plate in a line through which the solution flows, or by adding gasified water (or other suitable liquid), e.g., as in a conventional soda fountain. In such a circumstance, the onset of effervescence will be set as the time when dispensing of the solution into a container for measurement is completed.

Although bubbles in a gasified solution may come from other sources, such as agitation or sparging, the bubbles measured to determine the mean diameter should be bubbles “native” to the gaseous aqueous solution, i.e., arise from the gas dissolved in the solution.

Bubbles formed in gaseous aqueous solutions that include bubble modifier may have other useful attributes. For example, the bubbles may persist longer in the matrix of the solution or on a surface of the container in a gaseous aqueous solution with bubble modifier than in the same gaseous aqueous solution without the bubble modifier. Bubbles may also have a slower release time from a surface of the container in a gaseous aqueous solution with bubble modifier than in the same gaseous aqueous solution without the bubble modifier. This can make a gaseous aqueous beverage including bubble modifier more visually appealing because it looks more bubbly than the same beverage without the bubble modifier.

### Methods

A method for decreasing the size of bubbles formed by a gasified aqueous solution, the method comprising adding a bubble modifier to an aqueous solution after, or more desirably before or at the time of gasification of the aqueous solution.

A method for increasing volume, volumetric stability, foam capacity, foam expansion, and/or the foam density of a foam produced by an aqueous solution, the method comprising adding a bubble modifier and a steviol glycoside to an aqueous solution after, or more desirably before or at the time of gasification of the aqueous solution.

### EXAMPLES

The following examples are provided to illustrate the disclosure, but are not intended to limit the scope thereof. All parts and percentages are by weight unless otherwise indicated.

### Example 1

### Protocol 1

Protocol 1 used a fixed air gas sparging time of either 40 s or 60 s to analyze properties of the respective samples. Briefly, measurements were carried out with a Foamscan™ instrument (Teclis Scientific, Marseille France). An initial liquid volume of 60 ml of an individual liquid sample was loaded into the vertical glass cylinder of the Foamscan™ instrument. Air gas was then sparged into the liquid sample at a gas flow rate of 150 ml/min for 40 s or 60 s to generate foam. The generated foam expanded above the surface of the liquid sample within the vertical glass cylinder. Foam generation and foam decay were monitored in real time from the beginning of the air gas injection until complete decay of the generated foam. The volume of the generated foam was measured in real time. The foam conductance was also measured in real time.

Foam capacity (FC), Foam Maximum Density (MD), Foam Expansion (FE), Foam Capacity (FC), and volumetric stability of the foam (t_{foam1/2}) were determined.

Foam capacity (FC) at time t was calculated as a total volume of foam (Vt(foam)) at time t over a total volume of sparged gas (Vt(gas)) in the following manner:

$$FC ( t ) = \frac{Vt ( foam )}{Vt ( gas )}$$

Foam Maximum Density (MD) was calculated using an initial volume of liquid (Vi(liquid)), a final volume of liquid (Vf(liquid)), and a final volume of foam (Vf(foam)) in the following manner:

$$MD = \frac{Vi ( liquid ) - Vf ( liquid )}{Vf ( foam )}$$

Foam Expansion (FE) was calculated using the final volume of foam (Vf(foam)), the initial volume of liquid (Vi(liquid)), and the final volume of liquid (Vf(liquid)) in the following manner:

$$FE = \frac{Vf ( foam )}{Vi ( liquid ) - Vf ( liquid )}$$

Final Foam Capacity (FC) was calculated as the final volume of foam (Vf(foam)) over the final volume of sparged gas (Vf(gas)) in the following manner:

$$FC = \frac{Vf ( foam )}{Vf ( gas )}$$

The volumetric stability of the foam (t_{foam1/2}) was determined as the time needed for the foam volume to decay by one half. A highest measured volume of foam was used as the final volume of foam (Vf(foam)). The total amount of gas that was sparged was used as the final volume of injected gas (Vf(gas)). The initial volume of the liquid sample that was loaded into the instrument was used as the initial volume of liquid (Vi(liquid)). A volume of the liquid at the time when the volume of foam reached its highest measurement was the final volume of liquid (Vf(liquid)). The final foam conductance was measured at the time when the generated foam reached its highest volume.

### Protocol 2

Protocol 2 used air gas sparging to create a fixed volume of foam to analyze properties of the respective samples. Briefly, measurements were carried out with a Foamscan™ foam analyzer (Teclis Scientific, Marseille France). An initial liquid volume of 60 ml of sample was loaded into the vertical glass cylinder of the Foamscan instrument. Air gas was then sparged into the liquid sample at a gas flow rate of 150 ml/min to generate foam. The generated foam expanded above the surface of the liquid sample and the air gas sparging was continued until 250 ml of foam was generated. Foam generation and foam decay were monitored in real time from the beginning of the air gas sparging until the complete decay of the generated foam. The volume of the generated foam was measured in real time. The foam conductance was also measured in real time. Foam capacity (FC), Foam Maximum Density (MD), Foam Expansion (FE), Foam Capacity (FC), and volumetric stability of the foam (t_{foam1/2}) were determined as described for Protocol 1.

### Example 2

### Sample Preparation

Samples corresponding to diet beverages were prepared with combinations of steviol glycoside, bubble modifier, citrate buffer, and/or flavors. High purity rebaudioside M (>95% total steviol glycoside compounds (JECFA 9+rebaudioside M) comprising ˜87.5% rebaudioside M and ˜10.4% rebaudioside D) was used. The bubble modifier was a botanical extract derived from yerba mate (Cargill lot #YM20180628) as described above. The bubble modifier comprised greater than 40% dicaffeoylquinic acids and/or salts thereof. Samples A, B, C, D, and E had the steviol glycoside concentrations, bubble modifier concentrations, and flavors as shown in Table 1.

TABLE 1

| | | Steviol | Bubble | |
|---|---|---|---|---|
| | | glycoside | modifier | |
| | | concentration | concentration | |
| Sample | Description | (ppm) | (ppm) | Flavor |
| A | Unflavored diet (RebM) | 500 | 0 | None |
| B | Unflavored diet | 0 | 250 | None |
| | (Bubble modifier) | | | |
| C | Unflavored diet | 500 | 250 | None |
| | (RebM + Bubble modifier) | | | |
| D | Diet lemon lime | 500 | 250 | Lemon |
| | (RebM + Bubble modifier) | | | Lime |
| E | Diet cola | 700 | 475 | Cola |
| | (RebM + Bubble modifier) | | | |

Samples A, B, C, D, and E were prepared with the components as shown in Table 2 and water added to volume. As indicated below, Samples A, B, C, D, and E were each pH buffered with an acidic citrate buffer system.

TABLE 2

| Ingredient | | | | | | |
|---|---|---|---|---|---|---|
| Description | Supplier | Sample A | Sample B | Sample C | Sample D | Sample E |
| Steviol | Cargill | 0.05% | — | 0.05% | 0.05% | 0.07% |
| glycoside | | (500 ppm) | | (500 ppm) | (500 ppm) | (700 ppm) |
| Bubble | Cargill | — | 0.025% | 0.025% | 0.025% | 0.0475% |
| modifier | | | (250 ppm) | (250 ppm0 | (250 ppm) | (475 ppm) |
| Citric Acid, | Cargill | 0.098% | 0.098% | 0.098% | 0.098% | — |
| anhydrous | | | | | | |
| Potassium | Cargill | 0.026% | 0.026% | 0.026% | 0.026% | — |
| Citrate, | | | | | | |
| monohydrate | | | | | | |
| Sodium | Spectrum | 0.015% | 0.015% | 0.015% | 0.015% | 0.025% |
| Benzoate | | | | | | |
| Natural | Kerry | — | — | — | 0.180% | — |
| Lemon-Lime | | | | | | |
| Flavor | | | | | | |
| Cola Flavor | Givaudan | | | | | 0.19% |
| Caffeine, | SAFC | | | | | 0.0095% |
| anhydrous | | | | | | |

Sample A was prepared by preheating water in an amount of about 20% of the desired final volume to 65° C., adding the corresponding amount of Reb M to the preheated water, covering, and allowing the Reb M to dissolve while stirring with a magnetic stir bar on a stir plate. After the Reb M dissolved, the remaining ingredients were added in the following order under stirring: sodium benzoate, potassium citrate, and citric acid. Water (20° C.) was added to the final desired volume and the sample stirred until fully dissolved. The sample had a pH of 3.2. The sample was transferred to a 12 fluid ounce glass bottle, labelled and sealed.

Sample B was prepared by preheating water in an amount of about 20% of the desired final volume to 40° C., adding the corresponding amount of bubble modifier to the preheated water, covering, and allowing the bubble modifier to dissolve while stirring with a magnetic stir bar on a stir plate. After the bubble modifier dissolved, the remaining ingredients were added in the following order under stirring: sodium benzoate, potassium citrate, and citric acid. Water (20° C.) was added to the final desired volume and the sample stirred until fully dissolved. The sample had a pH of 3.2. The sample was transferred to a 12 fluid ounce glass bottle, labelled and sealed.

Sample C was prepared by preheating water in an amount of about 20% of the desired final volume to 40° C., adding the corresponding amount of bubble modifier to the preheated water, covering, and allowing the bubble modifier to dissolve while stirring with a magnetic stir bar on a stir plate. The corresponding amount of Reb M was then added and stirred until dissolved. After the Reb M dissolved, the remaining ingredients were added in the following order under stirring: sodium benzoate, potassium citrate, and citric acid. Water (20° C.) was added to the final desired volume and the sample stirred until fully dissolved. The sample had a pH of 3.2. The sample was transferred to a 12 fluid ounce glass bottle, labelled and sealed.

Sample D was prepared by preheating water in an amount of about 20% of the desired final volume to 40° C., adding the corresponding amount of bubble modifier to the preheated water, covering, and allowing the bubble modifier to dissolve while stirring with a magnetic stir bar on a stir plate. The corresponding amount of Reb M was then added and stirred until dissolved. After the Reb M dissolved, the remaining ingredients were added in the following order under stirring: sodium benzoate, potassium citrate, citric acid, and lemon-lime flavor. Water (20° C.) was added to the final desired volume and the sample stirred until fully dissolved. The sample had a pH of 3.2. The sample was transferred to a 12 fluid ounce glass bottle, labelled and sealed.

Sample E was prepared by preheating water in an amount of about 20% of the desired final volume to 40° C., adding the corresponding amount of bubble modifier to the preheated water, covering, and allowing the bubble modifier compound to dissolve while stirring with a magnetic stir bar on a stir plate. The corresponding amount of Reb M was then added and stirred until dissolved. After the Reb M dissolved, the remaining ingredients were added in the following order under stirring: sodium benzoate and cola flavor. Phosphoric acid was added until a pH of 2.9-3.1 was achieved. Water (20° C.) was added to the final desired volume and the sample stirred until fully dissolved. The sample had a pH of between 2.9 and 3.1. The sample was transferred to a 12 fluid ounce glass bottle, labelled and sealed.

### Example 3

Samples A, B, C, D, and E were prepared as described in Example 2. Protocol 1 using a 40 s air gas sparging time at 150 ml/min was carried out to analyze foam properties of each of the individual Samples A-E. Several measurements were performed for each individual sample. The initial liquid volume was 60 ml. Air was used as the sparged gas. Foam capacity (FC), Foam Maximum Density (MD), Foam Expansion (FE), Foam Capacity (FC), and volumetric stability of the foam (t_{foam1/2}) were determined for each of Samples A-E. The final foam conductance was also measured.

The results for Protocol 1 (40 s of air gas sparging) are shown in Table 3.

TABLE 3
Protocol 1, 40 s of air sparging

| | | | | D | |
|---|---|---|---|---|---|
| | | | | (RebM, | E |
| | | | C | bubble | (RebM, |
| | | B | (RebM, | modifier) | Bubble |
| | A | (Bubble | Bubble | lemon- | modifier, |
| Sample | (RebM) | modifier) | modifier, | lime) | cola) |
| Number of | 3 | 3 | 2 | 2 | 3 |
| measurements | | | | | |
| Gas flow rate | 150 | 150 | 150 | 150 | 150 |
| (ml/min) | | | | | |
| Total time of | 40 | 40 | 40 | 40 | 40 |
| gas sparging | | | | | |
| (s) | | | | | |
| Final foam | 66 | 23 | 118 | 118 | 119 |
| volume (ml) | (SD = 10) | (SD = 1) | (SD = 2) | (SD = 0) | (SD = 3) |
| Final foam | 42.5 | 0.125 | 58.242 | 65.47 | 80.41 |
| conductance | | | | | |
| (μS) | | | | | |
| Total gas | 97 | 97 | 97 | 97 | 97 |
| volume (ml) | | | | | |
| Foam | 4.6 | 14.6 | 4.8 | 3.6 | 4 |
| Expansion | | | | | |
| (FE) | | | | | |
| Foam Capacity | 0.68 | 0.23 | 1.22 | 1.22 | 1.23 |
| (FC) | | | | | |
| Foam Max | 0.223 | 0.069 | 0.245 | 0.281 | 0.253 |
| Density (MD) | | | | | |
| Volumetric | 14 | 7.5 | 104 | 180 | 221 |
| Foam Stability | (SD = 2.1) | (SD = 0.6) | (SD = 10) | (SD = 18) | (SD = 10) |
| (s) | | | | | |
| Foam | 6 | 0 | 21.5 | 32 | 28.5 |
| Conductance | | | | | |
| Stability (s) | | | | | |

The final foam volumes of Sample A (RebM) and Sample B (bubble modifier) were 66 ml and 23 ml respectively. Samples C (RebM, bubble modifier), D (RebM, bubble modifier, lemon-lime flavor), and E (RebM, bubble modifier, cola flavor) had final foam volumes of 118 ml, 118 ml, and 119 ml, respectively. Each of the samples comprising both steviol glycoside and bubble modifier showed surprising increases in final foam volumes compared to the sample with only steviol glycoside. Each of the samples comprising both steviol glycoside and bubble modifier showed surprising increases in final foam volumes compared to the sample with only bubble modifier. The final foam volumes for the samples comprising both steviol glycoside and bubble modifier were about twice the final foam volume of the sample with only steviol glycoside. The final foam volumes for the samples comprising both steviol glycoside and bubble modifier were about five times the final foam volume of the sample with only bubble modifier.

The final foam capacities of Sample A (RebM) and Sample B (bubble modifier) were 0.68 and 0.23, respectively. Samples C (RebM, bubble modifier), D (RebM, bubble modifier, lemon-lime flavor), and E (RebM, bubble modifier, cola flavor) had final foam capacities of 1.22, 1.22, and 1.23, respectively. Each of the samples comprising both steviol glycoside and bubble modifier showed surprising increases in final foam capacity compared to the sample with only steviol glycoside. Each of the samples comprising both steviol glycoside and bubble modifier showed surprising increases in final foam capacity compared to the sample with only bubble modifier. The final foam capacities for the samples comprising both steviol glycoside and bubble modifier were almost twice the final foam capacities of the sample with only steviol glycoside. The final foam capacities for the samples comprising both steviol glycoside and bubble modifier were about five times the final foam capacity of the sample with only bubble modifier.

The final foam conductance of Sample A (RebM) and Sample B (bubble modifier) were 42.5 μS and 0.125 μS, respectively. Samples C (RebM, bubble modifier), D (RebM, bubble modifier, lemon-lime flavor), and E (RebM, bubble modifier, cola flavor) had final foam conductances of 58.242 μS, 65.47 μS, and 80.41 μS, respectively. Each of the samples comprising both steviol glycoside and bubble modifier showed surprising increases in final foam conductance compared to the sample with only steviol glycoside. Each of the samples comprising both steviol glycoside and bubble modifier showed surprising increases in final foam conductance compared to the sample with only bubble modifier. The final foam capacities for the samples comprising both steviol glycoside and bubble modifier were increased over the final foam conductances of the sample with only steviol glycoside.

The volumetric foam stabilities of Sample A (RebM) and Sample B (bubble modifier) were 14 s and 7.5 s, respectively. Samples C (RebM, bubble modifier), D (RebM, bubble modifier, lemon-lime flavor), and E (RebM, bubble modifier, cola flavor) had volumetric foam stabilities of 104 s, 180 s, and 221 s, respectively. Each of the samples comprising both steviol glycoside and bubble modifier showed surprising increases in volumetric foam stability compared to the sample with only steviol glycoside. Each of the samples comprising both steviol glycoside and bubble modifier showed surprising increases in volumetric foam stability compared to the sample with only bubble modifier. The volumetric foam stabilities for the samples comprising both steviol glycoside and bubble modifier were between about 7 and 16 times longer than the volumetric foam stability of the sample with only steviol glycoside. The volumetric foam stabilities for the samples comprising both steviol glycoside and bubble modifier were between about 13 and 29 times longer than the volumetric foam stability of the sample with only bubble modifier. The volumetric stability for Sample D and E were longer than the volumetric foam stability of the sample without flavor, Sample C. Sample E (cola flavor) had a longer volumetric foam stability (221 s) than Sample D (lemon-lime flavor) (180 s).

### Example 4

Samples A, B, C, D, and E were prepared as described in Example 2. Protocol 1 using a 60 s air gas sparging time at 150 ml/min was carried out to analyze foam properties of each of the individual Samples A-E. Several measurements were performed for each individual sample. The initial liquid volume was 60 ml. Air was used as the sparged gas. Foam capacity (FC), Foam Maximum Density (MD), Foam Expansion (FE), Foam Capacity (FC), and volumetric stability of the foam (t_{foam1/2}) were determined for each of Samples A-E. The final foam conductance was also measured.

The results for Protocol 1 (60 s of air gas sparging) are shown in Table 4.

TABLE 4
Protocol 1, 60 s of air sparging

| Sample | A | B | C | D | E |
|---|---|---|---|---|---|
| Number of | 3 | 1 | 3 | 2 | 3 |
| measurements | | | | | |
| Gas flow rate | 150 | 150 | 150 | 150 | 150 |
| (ml/min) | | | | | |
| Total time of | 60 | 60 | 60 | 60 | 60 |
| gas sparging | | | | | |
| (s) | | | | | |
| Final foam | 82 | 19 | 161 | 174 | 170 |
| volume (ml) | (SD = 4) | | (SD = 3) | (SD = 6) | (SD = 2) |
| Final foam | 43.600 | 0.192 | 47.981 | 76.210 | 67.613 |
| conductance | | | | | |
| (μS) | | | | | |
| Total gas | 147 | 147 | 147 | 147 | 147 |
| volume (ml) | | | | | |
| Foam | 5 | 19.3 | 4.8 | 3.5 | 4.43 |
| Expansion | | | | | |
| (FE) | | | | | |
| Foam Capacity | 0.56 | 0.13 | 1.097 | 1.19 | 1.153 |
| (FC) | | | | | |
| Foam Max | 0.198 | 0.052 | 0.207 | 0.289 | 0.255 |
| Density (MD) | | | | | |
| Volumetric | 17 | 11 | 49 | 90 | 53 |
| Foam Stability | (SD = 1) | | (SD = 4) | (SD = 3) | (SD = 11) |
| (s) | | | | | |
| Foam | 5 | 0 | 10 | 13 | 10 |
| Conductance | | | | | |
| Stability (s) | | | | | |

The final foam volumes of Sample A (RebM) and Sample B (bubble modifier) were 82 ml and 19 ml respectively. Samples C (RebM, bubble modifier), D (RebM, bubble modifier, lemon-lime flavor), and E (RebM, bubble modifier, cola flavor) had final foam volumes of 161 ml, 174 ml, and 170 ml, respectively. Each of the samples comprising both steviol glycoside and bubble modifier showed surprising increases in final foam volumes compared to the sample with only steviol glycoside. Each of the samples comprising both steviol glycoside and bubble modifier showed surprising increases in final foam volumes compared to the sample with only bubble modifier. The final foam volumes for the samples comprising both steviol glycoside and bubble modifier were about twice the final foam volume of the sample with only steviol glycoside. The final foam volumes for the samples comprising both steviol glycoside and bubble modifier were more than 8 times the final foam volume of the sample with only bubble modifier.

The final foam capacities of Sample A (RebM) and Sample B (bubble modifier) were 0.56 and 0.13, respectively. Samples C (RebM, bubble modifier), D (RebM, bubble modifier, lemon-lime flavor), and E (RebM, bubble modifier, cola flavor) had final foam capacities of 1.097, 1.19, and 1.153, respectively. Each of the samples comprising both steviol glycoside and bubble modifier showed surprising increases in final foam capacity compared to the sample with only steviol glycoside. Each of the samples comprising both steviol glycoside and bubble modifier showed surprising increases in final foam capacity compared to the sample with only bubble modifier. The final foam capacities for the samples comprising both steviol glycoside and bubble modifier were about twice the final foam capacities of the sample with only steviol glycoside. The final foam capacities for the samples comprising both steviol glycoside and bubble modifier were more than 8 times the final foam capacity of the sample with only bubble modifier.

The final foam conductance of Sample A (RebM) and Sample B (bubble modifier) were 443.600 μS and 0.192 μS, respectively. Samples C (RebM, bubble modifier), D (RebM, bubble modifier, lemon-lime flavor), and E (RebM, bubble modifier, cola flavor) had final foam conductances of 47.981 μS, 76.210 μS, and 67.613 μS, respectively. Each of the samples comprising both steviol glycoside and bubble modifier showed surprising increases in final foam conductance compared to the sample with only steviol glycoside. Each of the samples comprising both steviol glycoside and bubble modifier showed surprising increases in final foam conductance compared to the sample with only bubble modifier. The final foam conductances for the samples comprising both steviol glycoside and bubble modifier were increased over the final foam capacities of the sample with only steviol glycoside.

The volumetric foam stabilities of Sample A (RebM) and Sample B (bubble modifier) were 17 s and 11 s, respectively. Samples C (RebM, bubble modifier), D (RebM, bubble modifier, lemon-lime flavor), and E (RebM, bubble modifier, cola flavor) had volumetric foam stabilities of 49 s, 90 s, and 53 s, respectively. Each of the samples comprising both steviol glycoside and bubble modifier showed surprising increases in volumetric foam stability compared to the sample with only steviol glycoside. Each of the samples comprising both steviol glycoside and bubble modifier showed surprising increases in volumetric foam stability compared to the sample with only bubble modifier. The volumetric foam stabilities for the samples comprising both steviol glycoside and bubble modifier were between about 2 and 5 times longer than the volumetric foam stability of the sample with only steviol glycoside. The volumetric foam stabilities for the samples comprising both steviol glycoside and bubble modifier were between about 4 and 8 times longer than the volumetric foam stability of the sample with only bubble modifier. The volumetric stability for Sample D and E were longer than the volumetric foam stability of the sample without flavor, Sample C. Sample D (cola flavor) had a longer volumetric foam stability (53 s) than Sample E (lemon-lime flavor) (90 s).

### Example 5

Samples A, B, C, D, and E were prepared as described in Example 2. Protocol 2 using an air gas sparging rate of 150 ml/min to attain a volume of 250 ml of generated foam was carried out to analyze foam properties of each of the individual Samples A-E. Several measurements were performed for each individual sample. The initial liquid volume was 60 ml. Air was used as the sparged gas. Foam capacity (FC), Foam Maximum Density (MD), Foam Expansion (FE), Foam Capacity (FC), and volumetric stability of the foam (t_{foam1/2}) were determined for each of Samples A-E. The final foam conductance was also measured.

The results for Protocol 2 are shown in Table 5.

TABLE 5
Protocol 2, 250 ml foam height

| Sample | A | B | C | D | E |
|---|---|---|---|---|---|
| Number of | 1 | 0 | 1 | 1 | 1 |
| measurements | | | | | |
| Gas flow rate | 150 | — | 150 | 150 | 150 |
| (ml/min) | | | | | |
| Total time of | 68 | — | 133 | 87 | 91 |
| gas sparging | | | (89 s) | | |
| (s) | | | | | |
| Final foam | 90 | — | 195 | 250 | 250 |
| volume (ml) | | | (was set | | |
| | | | to 250) | | |
| Final foam | 45.511 | — | 76.55 | 81.436 | 101.518 |
| conductance | | | | | |
| (μS) | | | | | |
| Total gas | 167 | — | 330 | 215 | 222 |
| volume (ml) | | | | | |
| Foam | 5.6 | — | 4.4 | 4.6 | 6 |
| Expansion | | | | | |
| (FE) | | | | | |
| Foam Capacity | 0.54 | — | 0.38 | 1.17 | 1.1 |
| (FC) | | | | | |
| Foam Max | 0.179 | — | 0.228 | 0.22 | 0.165 |
| Density (MD) | | | | | |
| Volumetric | 16 | — | 20 | 66 | 23 |
| Foam Stability | | | | | |
| (s) | | | | | |
| Foam | 6 | — | 9 | 10 | 11 |
| Conductance | | | | | |
| Stability (s) | | | | | |

As shown in Table 5, because of insufficient foaming, Samples A(RebM), B(bubble modifier), and C(RebM, bubble modifier) did not result in complete data. Sample A only reached a final foam volume of 90 ml after 68 s of total gas sparging time. Sample B was not able to be tested due to very little generated foam. Sample C only reached a final foam volume of 195 ml. Therefore, although foam properties were determined for Samples A, B, and C, it is difficult to compare these foam properties with the foam properties of Samples D and E. Samples D and E generated sufficient foam to reach a fixed foam volume of 250 ml. The final foam capacities for Sample D and E were 1.17 and 1.1, respectively. The final foam conductances for Sample D and E were 81.436 μS and 101.518 μS, respectively. The volumetric foam stabilities for Sample D and Sample E were 66 s and 23 s respectively.

### Example 6

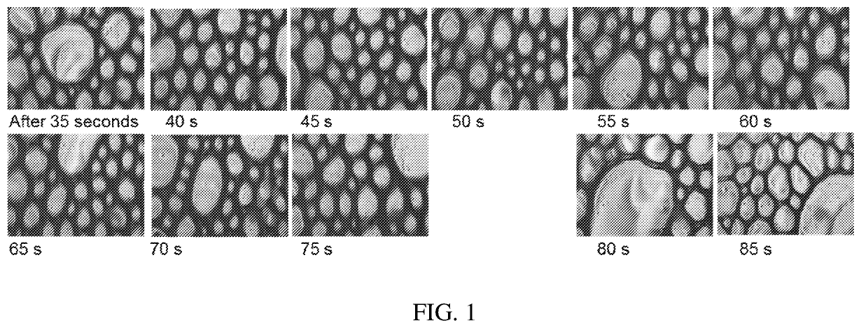

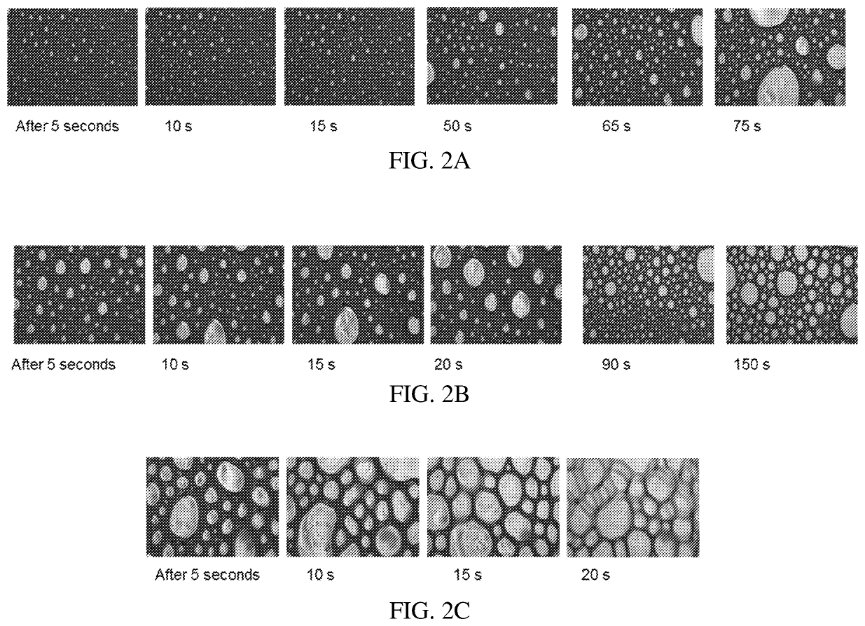

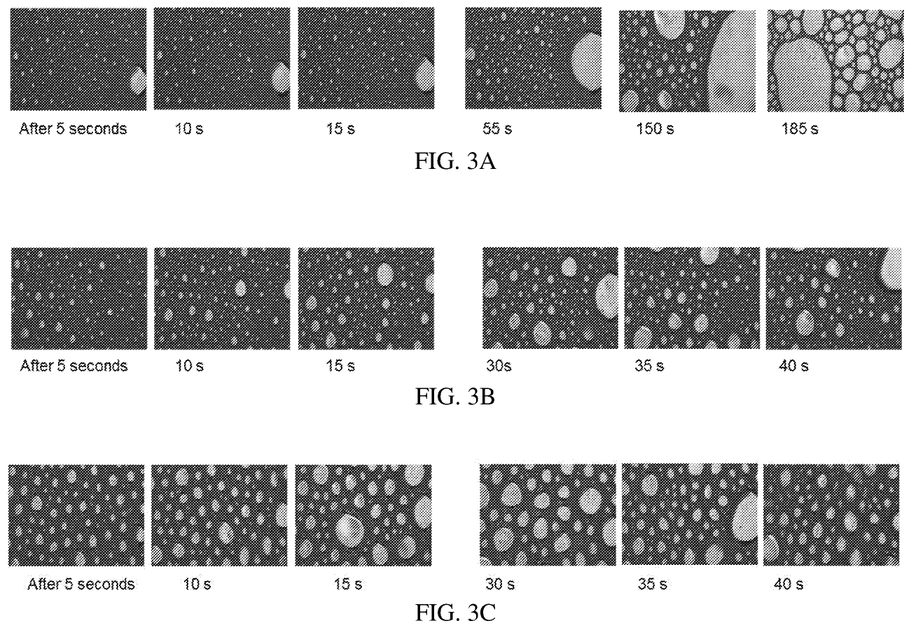

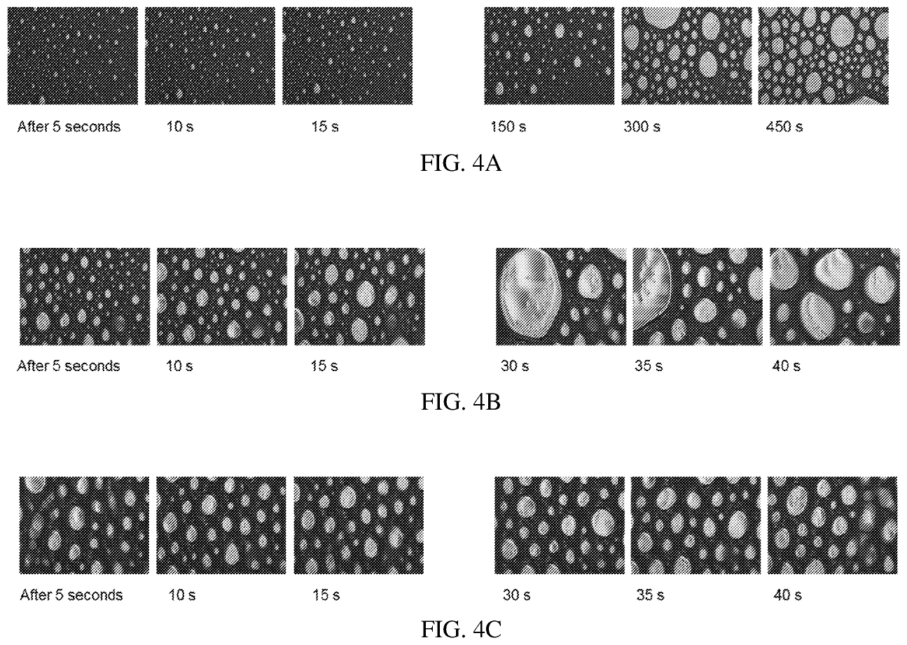

In each of Examples 3-5, bubble properties were observed by digital photography. Digital photos of foam bubbles in the respective samples were taken at regular intervals as the air gas sparging began, throughout the air gas sparging, and during decay of the generated foam. Digital photos were recorded for Samples A, C, D, and E. Digital photos of Sample B were not taken because very little foam was generated in the analysis of Sample B and the foam decay was rapid. FIGS. 1-4C show digital photos of Samples A, C, D, and E. FIG. 1 shows digital photos of bubbles for Sample A at after 35 s, at 40 s, at 45 s, at 50 s, at 55 s, at 60 s, at 65 s, at 70 s, at 75 s, at 80 s, and at 85 s for Example 3. FIG. 2A shows digital photos of bubbles for Sample C at after 5 s, at 10 s, at 15 s, at 50 s, at 65 s, and at 75 s for Example 3. FIG. 2B shows digital photos of bubbles for Sample C at after 5 s, at 10 s, at 15 s, at 20 s, at 90 s, and at 150 s for Example 4. FIG. 2C shows digital photos of bubbles for Sample C at after 5 s, at 10 s, at 15 s, and at 20 s for Example 5. FIG. 3A shows digital photos of bubbles for Sample D at after 5 s, at 10 s, at 15 s, at 55 s, at 150 s, and at 185 s for Example 3. FIG. 3B shows digital photos of bubbles for Sample D at after 5 s, at 10 s, at 15 s, at 30 s, at 35 s, and at 40 s for Example 4. FIG. 3C shows digital photos of bubbles for Sample D at after 5 s, at 10 s, at 15 s, at 30 s, at 35 s and at 40 s for Example 5. FIG. 4A shows digital photos of bubbles for Sample E at after 5 s, at 10 s, at 15 s, at 150 s, at 300 s, and at 450 s for Example 3. FIG. 4B shows digital photos of bubbles for Sample E at after 5 s, at 10 s, at 15 s, at 30 s, at 35 s, and at 40 s for Example 4. FIG. 4C shows digital photos of bubbles for Sample E at after 5 s, at 10 s, at 15 s, at 30 s, at 35 s and at 40 s for Example 5.

Mean bubble area at each time interval for individual samples was determined from the digital photos by analysis with software (Cellsize, Teclis Instruments) for Example 3. The mean bubble area for each of Samples C, D, and E were determined and the time to reach a bubble area of 0.04-0.1 mm² was determined. Table 5 lists the time range to reach a mean bubble area of 0.04-0.1 mm² for Samples C, D, and E of Example 3.

TABLE 6

| | Time range for mean bubble area to |
|---|---|
| Sample | reach 0.04-0.1 mm² |
| Sample C (Unflavored with | 85-120 s |
| RebM and bubble modifier) | |
| Sample D (Lemon-lime | 125-150 s |
| flavored with RebM and | |
| bubble modifier) | |
| Sample E (Cola flavored with | 215-445 s |
| RebM and bubble modifier) | |

Table 6 shows that the time range to reach a mean bubble area of 0.04-0.1 mm² is greater for samples with flavor (Samples D and E) than for the unflavored sample (Sample C). Table 6 also shows that the time range to reach a mean bubble area of 0.04-0.1 mm² is greater for samples with cola flavor (Sample D) than with lemon-lime flavor (Sample E).

### Example 7

Samples corresponding to diet beverages were prepared with combinations of steviol glycoside, bubble modifier, and/or flavors. High purity rebaudioside M (>95% total steviol glycosides (JECFA 9+Rebaudioside M) comprising ˜87.5% rebaudioside M and ˜10.4% rebaudioside D) was used. The bubble modifier was a botanical extract derived from yerba mate (Cargill lot #YM20180628) as described above. The bubble modifier comprised greater than 40% dicaffeoylquinic acids and/or salts thereof. Samples 1-9 had the steviol glycoside concentrations, bubble modifier concentrations, orange flavor, and/or sodium benzoate preservative (final concentration 0.015%) as shown below in Table 11. The samples were either unflavored (water) or orange flavored. The samples were prepared with distilled water. The samples were unbuffered except for Sample 5 which had 0.098% citric acid anhydrous and 0.026% potassium citrate monohydrate.

TABLE 11

| | | | Bubble | |
|---|---|---|---|---|
| | | RebM | modifier | Sodium |
| | | concentration | concentration | Benzoate |
| Sample | Description | (ppm) | (ppm) | Preservative |
| 1 | Water (RebM) | 500 | 0 | |
| 2 | Orange flavored | 500 | 0 | |
| | (RebM) | | | |
| 3 | Water (bubble | | 250 | |
| | modifier) | | | |
| 4 | Orange flavored | | 250 | |
| | (bubble modifier) | | | |
| 5 | Water (RebM, | 500 | 250 | |
| | bubble modifier) | | | |
| 6 | Orange flavored | 500 | 250 | |
| | (RebM, | | | |
| | bubble modifier) | | | |
| 7 | Water (RebM, | 500 | 250 | 150 ppm |
| | bubble modifier, | | | |
| | preservative) | | | |
| 8 | Orange flavored | 500 | 250 | 150 ppm |
| | (RebM, | | | |
| | bubble modifier, | | | |
| | preservative) | | | |
| 9 | Acid buffered | 500 | 250 | 150 pm |
| | (RebM, | | | |
| | bubble modifier, | | | |
| | preservative) | | | |

Samples 1-9 were prepared as described. Protocol 1 using a 40 s air gas sparging time at 150 ml/min was carried out to analyze foam properties of each of the individual Samples 1-9. Several measurements were performed for each individual sample. The initial liquid volume was 60 ml. Air, nitrogen gas, and carbon dioxide gas were each used individually as the sparged gas for each of Samples 1-9, individually. Foam capacity (FC), Foam Maximum Density (MD), Foam Expansion (FE), Foam Capacity (FC), and volumetric stability of the foam (t_{foam1/2}) were determined for each of Samples 1-9. The final foam conductance was also measured.

The results for Protocol 1 (40 s of air gas, nitrogen gas, and carbon dioxide gas sparging) for Samples 1 and 2 are shown in Table 12.

TABLE 12

| Gas | Air | N₂ | CO₂ | Air | N₂ | CO₂ |
|---|---|---|---|---|---|---|
| Sample | 1 (Water, | 1 (Water, | 1 (Water, | 2 (Orange, | 2 (Orange, | 2 (Orange, |
| | RebM) | RebM) | RebM) | RebM) | RebM) | RebM) |
| Number of | 3 | 3 | 3 | 3 | 3 | 3 |
| measurements | | | | | | |
| Gas Flow | 150 | 150 | 150 | 150 | 150 | 150 |
| Rate (ml/min) | | | | | | |
| Total time | 40 | 40 | 40 | 40 | 40 | 40 |
| of gas | | | | | | |
| sparging (s) | | | | | | |
| Final foam | 114 | 120 | 27 | 123 | 125 | 20 |
| volume (ml) | (SD = 3) | (SD = 1.5) | (SD = 2.1) | (SD=) | (SD = 1) | (SD = 1) |
| Final foam | 1.949 | 2.067 | 0.194 | 2.563 | 2.358 | 0.208 |
| conductance | | | | | | |
| (μS) | | | | | | |
| Total gas | 97 | 97 | 98 | 97 | 97 | 98 |
| volume (ml) | | | | | | |
| Foam | 5.4 | 5.1 | 0 | 4.1 | 4.1 | 0 |
| Expansion | | | | | | |
| (FE) | | | | | | |
| Foam Capacity | 1.18 | 1.24 | 0.27 | 1.27 | 1.29 | 0.21 |
| (FC) | | | | | | |
| Foam Max | 0.184 | 0.197 | — | 0.246 | 0.246 | — |
| Density (MD) | | | | | | |
| Volumetric | 114 | 138 | 14 | 171 | 181 | 4 |
| Foam | (SD = 17.8) | (SD = 24.8) | (SD = 3.8) | (SD = 17) | (SD = 6.7) | (SD = 0) |
| Stability (s) | | | | | | |
| Foam | 77 | 52 | 0 | 74 | 78 | 0 |
| Conductance | | | | | | |
| Stability (s) | | | | | | |

Table 12 shows that for Sample 1, sparging with carbon dioxide gas decreased final foam volume and foam capacity compared to either sparging with air or sparging with nitrogen. Table 12 shows that for Sample 2, sparging with carbon dioxide gas decreased final foam volume and foam capacity compared to either sparging with air or sparging with nitrogen.

The results for Protocol 1 (40 s of air gas, nitrogen gas, and carbon dioxide gas sparging) for Samples 3 and 4 are shown in Table 13.

TABLE 13

| Gas | Air | N₂ | CO₂ | Air | N₂ | CO₂ |
|---|---|---|---|---|---|---|
| Sample | 3 (Water, | 3 (Water, | 3 (Water, | 4 (Orange, | 4 (Orange, | 4 (Orange, |
| | Bubble | Bubble | Bubble | Bubble | Bubble | Bubble |
| | modifier) | modifier) | modifier) | modifier) | modifier) | modifier) |
| Number of | 3 | 3 | 3 | 3 | 3 | 3 |
| measurements | | | | | | |
| Gas Flow | 150 | 150 | 150 | 150 | 150 | 150 |
| Rate | | | | | | |
| (ml/min) | | | | | | |
| Total time | 40 | 40 | 40 | 40 | 40 | 40 |
| of gas | | | | | | |
| sparging (s) | | | | | | |
| Final foam | 3 | 4 | 5.3 | 60 | 73 | 27 |
| volume (ml) | (SD = 1.7) | (SD = 1) | (SD = 1.2) | (SD = 0) | (SD = 9) | (SD = 2) |
| Final foam | 0.196 | 0.196 | 0.191 | 6.187 | 5.582 | 0.191 |
| conductance | | | | | | |
| (μS) | | | | | | |
| Total gas | 97 | 97 | 98 | 97 | 97 | 98 |
| volume (ml) | | | | | | |
| Foam | 0 | 0 | 0 | 3.3 | 3.1 | 0 |
| Expansion | | | | | | |
| (FE) | | | | | | |
| Foam | 0.03 | 0.04 | 0.05 | 0.85 | 0.75 | 0.28 |
| Capacity | | | | | | |
| (FC) | | | | | | |
| Foam Max | — | — | — | 0.31 | 0.326 | — |
| Density (MD) | | | | | | |
| Volumetric | 1 | 1 | 1 | 17 | 10 | 29 |
| Foam | (SD = 0) | (SD = 0) | (SD = 1) | (SD = 6.0) | (SD = 1.5) | (SD = 5.9) |
| Stability (s) | | | | | | |
| Foam | 0 | 0 | 0 | 11 | 7 | 0 |
| Conductance | | | | | | |
| Stability (s) | | | | | | |

Table 13 shows that for Sample 4, sparging with carbon dioxide gas decreased final foam volume and foam capacity compared to either sparging with air or sparging with nitrogen.

The results for Protocol 1 (40 s of air gas, nitrogen gas, and carbon dioxide gas sparging) for Samples 5 and 6 are shown in Table 14.

TABLE 14

| | Gas | | | | | |
|---|---|---|---|---|---|---|
| | Air | N₂ | CO₂ | Air | N₂ | CO₂ |
| | Sample | | | | | |
| | | | | 6 | 6 | 6 |
| | 5 (Water, | 5 (Water, | 5 (Water, | (Orange, | (Orange, | (Orange, |
| | RebM, | RebM, | RebM, | RebM, | RebM, | RebM, |
| | Bubble | Bubble | Bubble | Bubble | Bubble | Bubble |
| | modifier) | modifier) | modifier) | modifier) | modifier) | modifier) |
| Number of | 3 | 3 | 3 | 3 | 3 | 3 |
| measurements | | | | | | |
| Gas Flow Rate | 150 | 150 | 150 | 150 | 150 | 150 |
| (ml/min) | | | | | | |
| Total time of | 40 | 40 | 40 | 40 | 40 | 40 |
| gas sparging | | | | | | |
| (s) | | | | | | |
| Final foam | 117 | 116 | 35 | 119 | 124 | 34 |
| volume (ml) | (SD = 2) | (SD = 4) | (SD = 0) | (SD = 4) | (SD = 3) | (SD = 1) |
| Final foam | 3.064 | 2.815 | 0.796 | 4.887 | 5.388 | 0.328 |
| conductance | | | | | | |
| (μS) | | | | | | |
| Total gas | 97 | 97 | 98 | 97 | 97 | 98 |
| volume (ml) | | | | | | |
| Foam | 5.3 | 5.4 | 0 | 3.9 | 3.9 | 0 |
| Expansion | | | | | | |
| (FE) | | | | | | |
| Foam Capacity | 1.21 | 1.20 | 0.36 | 1.23 | 1.28 | 0.35 |
| (FC) | | | | | | |
| Foam Max | 0.188 | 0.185 | — | 0.260 | 0.257 | — |
| Density (MD) | | | | | | |
| Volumetric | 137 | 135 | 33 | 114 | 142 | 18 |
| Foam Stability | (SD = 15) | (SD = 14.4) | (SD = 13) | (SD = 20.6) | (SD = 21.4) | (SD = 6.1) |
| (s) | | | | | | |
| Foam | 51 | 52 | 14 | 59 | 54 | 0 |
| Conductance | | | | | | |
| Stability (s) | | | | | | |

Table 14 shows that for Sample 5, sparging with carbon dioxide gas decreased final foam volume and foam capacity compared to either sparging with air or sparging with nitrogen. Table 14 shows that for Sample 6, sparging with carbon dioxide gas decreased final foam volume and foam capacity compared to either sparging with air or sparging with nitrogen.

The results for Protocol 1 (40 s of air gas, nitrogen gas, and carbon dioxide gas sparging) for Samples 7 and 8 are shown in Table 15.

TABLE 15

| Gas | Air | N₂ | CO₂ | Air | N₂ | CO₂ |
|---|---|---|---|---|---|---|
| Sample | 7 (Water, | 7 (Water, | 7 (Water, | 8 (Orange, | 8 (Orange, | 8 (Orange, |
| | RebM, | RebM, | RebM, | RebM, | RebM, | RebM, |
| | Bubble | Bubble | Bubble | Bubble | Bubble | Bubble |
| | modifier, | modifier, | modifier, | modifier, | modifier, | modifier, |
| | preservative) | Preservative) | Preservative) | Preservative) | Preservative) | Preservative) |
| Number of | 3 | 3 | 3 | 3 | 3 | 3 |
| measurements | | | | | | |
| Gas Flow | 150 | 150 | 150 | 150 | 150 | 150 |
| Rate | | | | | | |
| (ml/min) | | | | | | |
| Total time | 40 | 40 | 40 | 40 | 40 | 40 |
| of gas | | | | | | |
| sparging (s) | | | | | | |
| Final foam | 109 | 119 | 36 | 44 | 41 | 15 |
| volume (ml) | (SD = 4) | (SD = 1) | (SD = 1) | (SD = 5) | (SD = 3) | (SD = 1) |
| Final foam | 10.463 | 10.837 | 1.893 | 35.737 | 12.445 | 0.191 |
| conductance | | | | | | |
| (μS) | | | | | | |
| Total gas | 97 | 97 | 98 | 97 | 97 | 98 |
| volume (ml) | | | | | | |
| Foam | 4.8 | 4.8 | 0 | 3.2 | 3.4 | 34.2 |
| Expansion | | | | | | |
| (FE) | | | | | | |
| Foam | 1.12 | 1.23 | 0.37 | 0.45 | 0.42 | 0.16 |
| Capacity | | | | | | |
| (FC) | | | | | | |
| Foam Max | 0.209 | 0.207 | — | 0.326 | 0.292 | 0.032 |
| Density (MD) | | | | | | |
| Volumetric | 153 | 164 | 57 | 10 | 8 | 4 |
| Foam | (SD = 12.7) | (SD = 11.5) | (SD = 4) | (SD = 2.1) | (SD = 0.6) | (SD = 0) |
| Stability (s) | | | | | | |
| Foam | 45 | 47 | 13 | 2 | 3 | 0 |
| Conductance | | | | | | |
| Stability (s) | | | | | | |

Table 15 shows that for Sample 7, sparging with carbon dioxide gas decreased final foam volume and foam capacity compared to either sparging with air or sparging with nitrogen. Table 15 shows that for Sample 8, sparging with carbon dioxide gas decreased final foam volume and foam capacity compared to either sparging with air or sparging with nitrogen.

The results for Protocol 1 (40 s of air gas, nitrogen gas, and carbon dioxide gas sparging) for Sample 9 are shown in Table 16.

TABLE 16

| Gas | Air | N₂ | CO₂ |
|---|---|---|---|
| Sample | 9 (Acid Buffered | 9 (Acid Buffered | 9 (Acid Buffered |
| | Water, RebM, | Water, RebM, | Water, RebM, |
| | Bubble modifier, | Bubble modifier, | Bubble modifier, |
| | Preservative) | Preservative) | Preservative) |
| Number of | 3 | 3 | 3 |
| measurements | | | |
| Gas Flow Rate | 150 | 150 | 150 |
| (ml/min) | | | |
| Total time of gas | 40 | 40 | 40 |
| sparging (s) | | | |
| Final foam | 74 | 75 | 32 |
| volume (ml) | (SD = 2) | (SD = 3) | (SD = 3) |
| Final foam | 67.282 | 70.556 | 0.614 |
| conductance (μS) | | | |
| Total gas volume | 97 | 97 | 98 |
| (ml) | | | |
| Foam Expansion | 3.1 | 3.1 | 11 |
| (FE) | | | |
| Foam Capacity | 0.77 | 0.77 | 0.33 |
| (FC) | | | |
| Foam Max | 0.320 | 0.327 | 0.091 |
| Density (MD) | | | |
| Volumetric Foam | 18 | 18 | 14 |
| Stability (s) | (SD = 1.2) | (SD = 1.5) | (SD = 1.2) |
| Foam | 9 | 9 | 3 |
| Conductance | | | |
| Stability (s) | | | |

Table 16 shows that for Sample 9, sparging with carbon dioxide gas decreased final foam volume and foam capacity compared to either sparging with air or sparging with nitrogen.

### Example 8

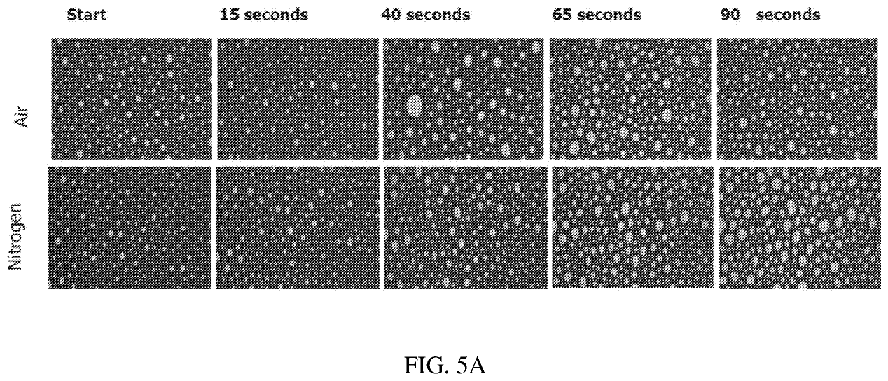

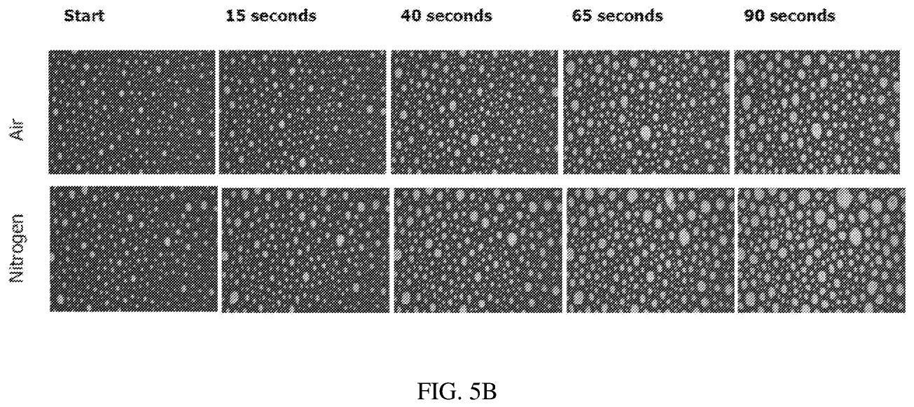

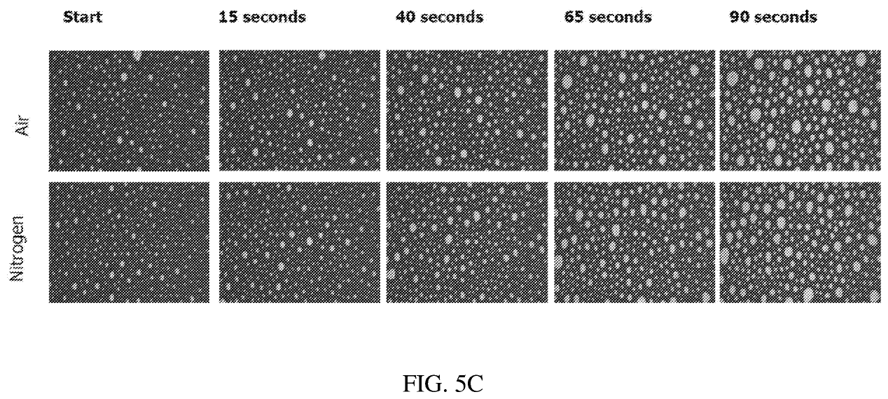

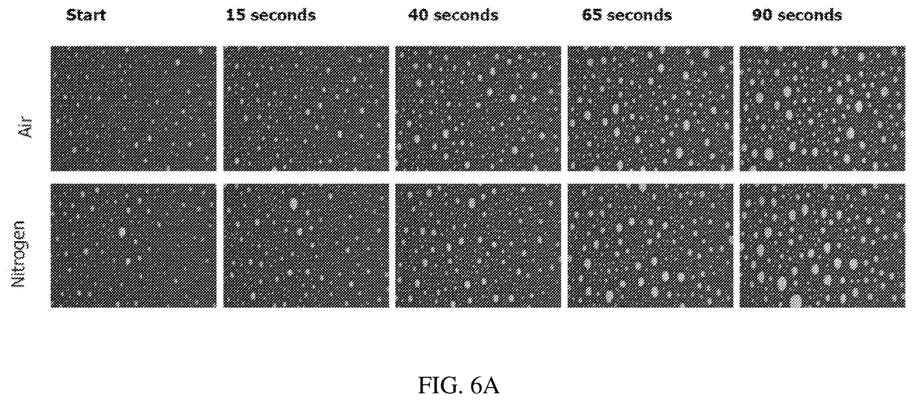

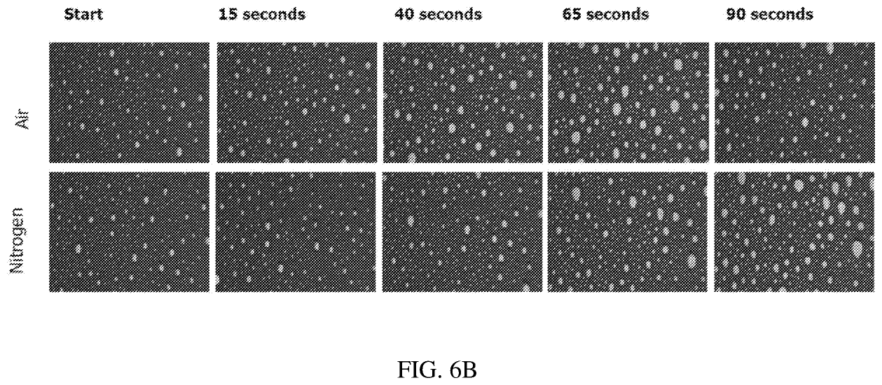

For Examples 8, bubble properties were observed by digital photography. Digital photos of foam bubbles in the respective samples were taken at regular intervals as the air gas sparging began, throughout the air gas sparging, and during decay of the generated foam. Digital photos were recorded for Samples 1, 2, 5, 6, and 7 with air gas sparging and nitrogen gas sparging. Digital photos were recorded at 0 s, 15 s, 40 s, 65 s, and 90 s. FIG. 5A shows digital photos of bubbles for Sample 1 (Water (RebM)) with air gas sparging and nitrogen gas sparging at 0 s, 15 s, 40 s, 65 s, and 90 s. FIG. 5B shows digital photos of bubbles for Sample 5 (Water (RebM, bubble modifier)) with air gas sparging and nitrogen gas sparging at 0 s, 15 s, 40 s, 65 s, and 90 s. FIG. 5C shows digital photos of bubbles for Sample 7 (Water (RebM, bubble modifier, preservative)) with air gas sparging and nitrogen gas sparging at 0 s, 15 s, 40 s, 65 s, and 90 s. FIG. 6A shows digital photos of bubbles for Sample 2 (Orange flavored (RebM)) with air gas sparging and nitrogen gas sparging at 0 s, 15 s, 40 s, 65 s, and 90 s. FIG. 6B shows digital photos of bubbles for Sample 6 (Orange flavored (RebM, bubble modifier)) with air gas sparging and nitrogen gas sparging at 0 s, 15 s, 40 s, 65 s, and 90 s.

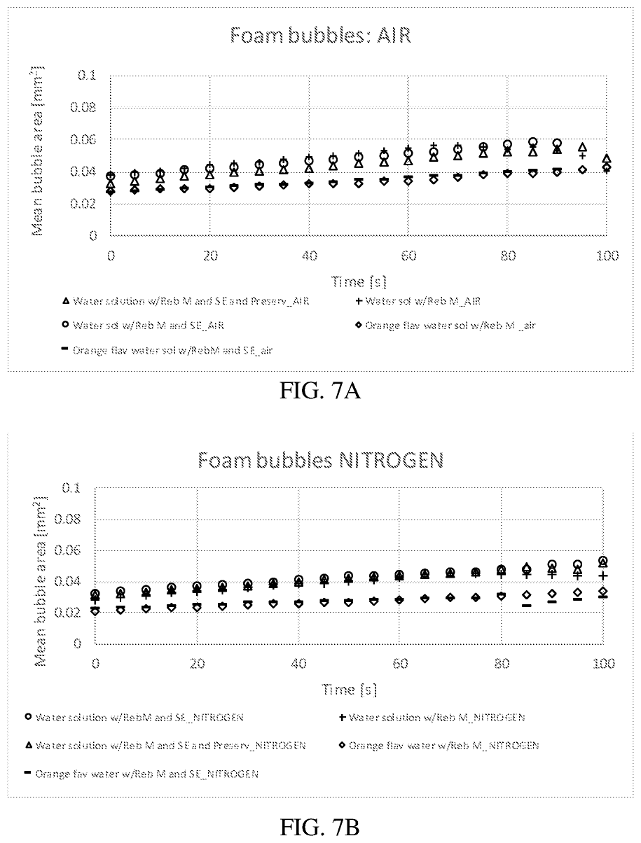

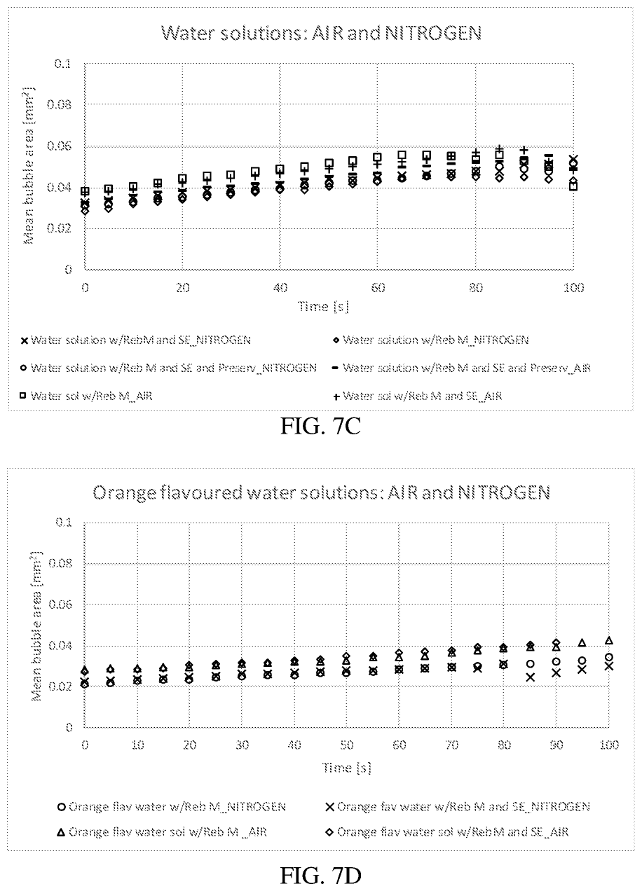

FIG. 7A is a graph plotting the calculated mean bubble area over a span of 100 seconds for bubbles in the pictures in FIGS. 5-6 for samples that were sparged with air. FIG. 7B is a graph plotting the calculated mean bubble area over a span of 100 seconds for bubbles in the pictures in FIGS. 5-6 for samples that were sparged with nitrogen. FIG. 7C is a graph plotting the calculated mean bubble area over a span of 100 seconds for bubbles in the pictures in FIGS. 5-6 for samples that were sparged with air and nitrogen. FIG. 7B is a graph plotting the calculated mean bubble area over a span of 100 seconds for bubbles in the pictures in FIGS. 5-6 for orange flavored water samples that were sparged with air and nitrogen.

### Example 9

A beverage model system (carbonated water) was prepared with and without bubble enhancer. Samples were prepared by dosing a small amount of a concentrated SE solution (1% in still water) into 1 oz in plastic portion cups and filling with carbonated water to attain final concentrations from 0 to 600 ppm in 100 ppm increments. Comments below are from four personnel familiar with beverage sensory evaluation.

Carbonated Water (0-600 ppm):

Visual
a. For the systems containing bubble modifier, an increase in number of bubbles sticking to the side of the plastic cups.
b. For the systems containing bubble modifier, a decrease in size of bubbles sticking to the side of the plastic cups.
c. For the systems containing bubble modifier, the bubbles appeared to coalesce slower as the concentration of bubble modifier increased.
d. For the systems containing bubble modifier, the smaller bubbles persisted on the walls of the plastic cup longer.
e. No noticeable color in the solutions at 400 ppm bubble modifier or less.

Taste
a. Noticeable increase in “fineness” of bubble mouthfeel in the systems containing bubble modifier than to the one that didn't include any bubble modifier.
b. One person noted a faint increase in acidity perception at 300 ppm bubble modifier.
c. Faint astringency experienced at 500 ppm bubble modifier.
d. Slight astringency experienced at 600 ppm bubble modifier.
e. One person noted a faint “brown fruit” taste at 600 ppm bubble modifier.

No other botanical flavors perceived at any of the concentrations.

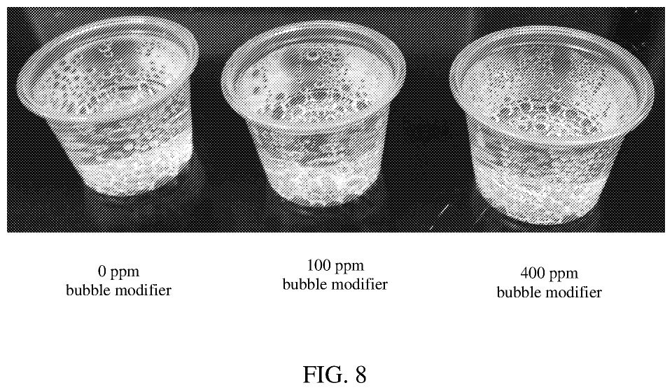

FIG. 8 is a photograph showing, from left to right, the samples having 0 ppm, 100 ppm, and 400 ppm of bubble modifier.

1. A gasified aqueous solution with a reduced mean bubble diameter, comprising:
a. dissolved gas at a level that will cause the gasified aqueous solution to effervesce at 15.6° C. and an ambient air pressure of 1 atmosphere (STP), and
b. a bubble modifier comprising one or more compounds selected from the group consisting of monocaffeoylquinic acids, dicaffeoylquinic acids, monoferuloylquinic acids, diferuloylquinic acids, monocoumaroylquinic acids, dicoumaroylquinic acids, and salts thereof, said one or more compounds present in the gasified aqueous solution at a total concentration of 50 ppm to 1600 ppm that is effective to reduce a mean bubble diameter within a matrix of the aqueous solution, at STP within 1 minute of an onset of effervescence, compared to the gasified aqueous solution without the bubble modifier;
wherein the bubble modifier comprises a dicaffeoylquinic component that includes at least one compound selected from the group consisting of 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, 4,5-dicaffeoylquinic acid, and salts thereof; and
wherein the bubble modifier comprises less than 0.3% (wt) of malonate, malonic acid, oxalate, oxalic acid, lactate, lactic acid, succinate, succinic acid, malate, or malic acid; or less than 0.05% (wt) of pyruvate, pyruvic acid, fumarate, fumaric acid, tartrate, tartaric acid, sorbate, sorbic acid, acetate, or acetic acid; or less than about 0.05% (wt) of chlorophyll; or less than about 0.1% (wt) of furans, furan-containing chemicals, theobromine, theophylline, or trigonelline as weight percentage on a dry weight basis of the bubble modifier.

2. The gasified aqueous solution of claim 1, wherein the concentration of the bubble modifier is 50 ppm to 600 ppm, 50 ppm to 500 ppm, 50 ppm to 400 ppm, 50 ppm to 300 ppm, 100 ppm to 600 ppm, 100 ppm to 500 ppm, 100 ppm to 400 ppm, or 100 ppm to 300 ppm.

3. The gasified aqueous solution of claim 1, wherein the bubble modifier comprises a dicaffeoylquinic component that includes at least one compound selected from the group consisting of 3,4-dicaffeoylquinic acid, 3,5-dicaffeoylquinic acid, 4,5-dicaffeoylquinic acid, and salts thereof.

4. The gasified aqueous solution of claim 1, wherein the total of all dicaffeoylquinic acids and dicaffeoylquinic salts present in the bubble modifier comprises 10% (wt) or more, 15 wt % or more, 20% (wt) or more, 25% (wt) or more, 30% (wt) or more, 35% (wt) or more, 40% (wt) or more, 45% (wt) or more, 50% (wt) or more, 60% (wt) or more, 70% (wt) or more, 25-75% (wt), or 40-60% (wt) of a total weight of the bubble modifier.

5. The gasified aqueous solution of claim 1, wherein the bubble modifier comprises a dicaffeoylquinic component that includes at least one compound selected from the group consisting of 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, 4,5-dicaffeoylquinic acid, and salts thereof; and a monocaffeoylquinic component that includes at least one compound selected from the group consisting of chlorogenic acid, neochlorogenic acid, cryptochlorogenic acid, and salts thereof.

6. The gasified aqueous solution of claim 1, wherein the bubble modifier comprises a dicaffeoylquinic component that includes at least one compound selected from the group consisting of 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, 4,5-dicaffeoylquinic acid, and salts thereof; and a monocaffeoylquinic component that includes at least one compound selected from the group consisting of chlorogenic acid, neochlorogenic acid, cryptochlorogenic acid, and salts thereof; and wherein the monocaffeoylquinic component and the dicaffeoylquinic component together comprise more than 50% (wt), preferably more than 60% (wt), more than 70% (wt), more than 80% (wt), more than 90% (wt), or more than 95% (wt) of the bubble modifier.

7. The gasified aqueous solution of claim 1, wherein the solution is gasified with the gas at a level at least 50%, preferably at least 100%, at least 200%, or at least 300% higher than an equilibrium saturation value of the gas at STP.

8. The gasified aqueous solution of claim 1, wherein the bubble modifier comprises 0% (wt) of malonate, malonic acid, oxalate, oxalic acid, lactate, lactic acid, succinate, succinic acid, malate, or malic acid; or 0% (wt) of chlorophyll.

9. A beverage product comprising the gasified aqueous solution of claim 1.

10. A non-alcoholic beverage product comprising the gasified aqueous solution of claim 1.

11. A modified steviol glycoside solution that forms a foam with a reduced mean bubble diameter, comprising
a. steviol glycoside at a concentration of at least 20 ppm, preferably at least 50 ppm; and
b. a bubble modifier comprising one or more compounds selected from the group consisting of monocaffeoylquinic acids, dicaffeoylquinic acids, monoferuloylquinic acids, diferuloylquinic acids, monocoumaroylquinic acids, dicoumaroylquinic acids, and salts thereof, said one or more compounds present in the modified steviol glycoside solution at a concentration of 50 ppm to 1600 ppm, that is effective to reduce a mean bubble diameter in the foam compared to the aqueous solution without the bubble modifier;
wherein the mean bubble diameter is measured by the Foamscan test, with an airflow rate of 150 ml/min delivered for 60 seconds to 60 ml of the modified steviol glycoside solution having a temperature of 15.6° C. and determining the mean bubble diameter of bubbles in the foam at a pressure of 1 atmosphere 30 seconds after delivery of the gas is complete;
wherein the modified steviol glycoside solution comprises a ratio of total concentration of the one or more compounds selected from the group consisting of monocaffeoylquinic acids, dicaffeoylquinic acids, monoferuloylquinic acids, diferuloylquinic acids, monocoumaroylquinic acids, dicoumaroylquinic acids, and salts thereof to steviol glycoside between 0.1 and 10; and
wherein the bubble modifier comprises less than 0.3% (wt) of malonate, malonic acid, oxalate, oxalic acid, lactate, lactic acid, succinate, succinic acid, malate, or malic acid; or less than 0.05% (wt) of pyruvate, pyruvic acid, fumarate, fumaric acid, tartrate, tartaric acid, sorbate, sorbic acid, acetate, or acetic acid; or less than about 0.05% (wt) of chlorophyll; or less than about 0.1% (wt) of furans, furan-containing chemicals, theobromine, theophylline, or trigonelline as weight percentage on a dry weight basis of the bubble modifier.

12. The modified steviol glycoside solution of claim 11, wherein the bubble modifier comprises a dicaffeoylquinic component that includes at least one compound selected from the group consisting of 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, 4,5-dicaffeoylquinic acid, and salts thereof.

13. The modified steviol glycoside solution of claim 11, wherein the concentration of the bubble modifier is 50 ppm to 600 ppm, 50 ppm to 500 ppm, 50 ppm to 400 ppm, 50 ppm to 300 ppm, 100 ppm to 600 ppm, 100 ppm to 500 ppm, 100 ppm to 400 ppm, or 100 ppm to 300 ppm.

14. The modified steviol glycoside solution of claim 11, wherein the bubble modifier comprises a dicaffeoylquinic component that includes at least one compound selected from the group consisting of 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, 4,5-dicaffeoylquinic acid, and salts thereof.

15. The modified steviol glycoside solution of claim 11, wherein the total of all dicaffeoylquinic acids and dicaffeoylquinic salts present in the bubble modifier comprises 10% (wt) or more, 15 wt % or more, 20% (wt) or more, 25% (wt) or more, 30% (wt) or more, 35% (wt) or more, 40% (wt) or more, 45% (wt) or more, 50% (wt) or more, 60% (wt) or more, 70% (wt) or more, 25-75% (wt), or 40-60% (wt) of a total weight of the bubble modifier.

16. The modified steviol glycoside solution of claim 11, wherein the bubble modifier comprises a dicaffeoylquinic component that includes at least one compound selected from the group consisting of 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, 4,5-dicaffeoylquinic acid, and salts thereof; and a monocaffeoylquinic component that includes at least one compound selected from the group consisting of chlorogenic acid, neochlorogenic acid, cryptochlorogenic acid, and salts thereof.

17. The modified steviol glycoside solution of claim 11, wherein the bubble modifier comprises a dicaffeoylquinic component that includes at least one compound selected from the group consisting of 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, 4,5-dicaffeoylquinic acid, and salts thereof; and a monocaffeoylquinic component that includes at least one compound selected from the group consisting of chlorogenic acid, neochlorogenic acid, cryptochlorogenic acid, and salts thereof; and wherein the monocaffeoylquinic component and the dicaffeoylquinic component together comprise more than 50% (wt), preferably more than 60% (wt), more than 70% (wt), more than 80% (wt), more than 90% (wt), or more than 95% (wt) of the bubble modifier.

18. The modified steviol glycoside solution of claim 11, wherein the steviol glycoside comprises at least one of rebaudioside A, rebaudioside B, rebaudioside D, and rebaudioside M.

19. The modified steviol glycoside solution of claim 11, wherein the steviol glycoside comprises at least 80% (wt) of rebaudioside M based on a total weight of steviol glycoside compounds in the sweetened composition.

20. The modified steviol glycoside solution of claim 11, wherein the steviol glycoside concentration is 100 ppm to 1600 ppm, preferably 200 ppm to 1000 ppm, or more preferably 400 ppm to 800 ppm.

21. The modified steviol glycoside solution of claim 11, wherein the steviol glycoside concentration is 10 ppm to 25 ppm, preferably 20 ppm to 24 ppm, or more preferably 20 ppm.

22. The modified steviol glycoside solution of claim 11, wherein the steviol glycoside concentration is 100 ppm to 1600 ppm, preferably 200 ppm to 1000 ppm, or more preferably 400 ppm to 800 ppm and the bubble modifier concentration is 50 ppm to 400 ppm, 50 ppm to 300 ppm, 100 ppm to 400 ppm, or 100 ppm to 300 ppm.

23. The modified steviol glycoside solution of claim 11, wherein the sweetened composition has a pH of 2 to 4.

24. (canceled)

25. (canceled)

26. A beverage product comprising the modified steviol glycoside solution of claim 11, wherein the beverage is gasified with one or more gases selected from the group consisting of air, nitrogen, and carbon dioxide.

27. A modified steviol glycoside solution having an increased foam capacity or FC₃₀, comprising:
a. a steviol glycoside at a concentration of at least 10 ppm, preferably at least 50 ppm or at least 100 ppm; and
b. a bubble modifier at a concentration of 50 ppm to 1600 ppm,
wherein the bubble modifier and the steviol glycoside are each present at a concentration effective to provide the modified steviol glycoside solution with a foam capacity or FC₃₀ of at least 0.8, wherein foam capacity of FC₃₀ is determined as foam volume divided by volume of air delivered into the modified steviol glycoside solution in the Foamscan test.

28. The modified steviol glycoside solution of claim 27, wherein the bubble modifier and the steviol glycoside are each present in an amount effective to provide a foam capacity or FC₃₀ of at least 0.9, at least 1.0, at least 1.1, or at least 1.2.

29. The modified steviol glycoside solution of claim 27, wherein the bubble modifier comprises 10% (wt) or more, 15% (wt) or more, 20% (wt) or more, 25% (wt) or more, 30% (wt) or more, 35% (wt) or more, 40% (wt) or more, 45% (wt) or more, 50% (wt) or more, 60% (wt) or more, or 70% (wt) or more of compounds from the group consisting of dicaffeoylquinic acids and salts thereof, based on a total weight of the bubble modifier.

30. The modified steviol glycoside solution of claim 27, wherein the bubble modifier comprises monocaffeoylquinic acids comprising one or more compounds selected from the group consisting of 3-O-caffeoylquinic acid, 4-O-caffeoylquinic acid, and 5-O-caffeoylquinic acid.

31. The modified steviol glycoside solution of claim 27, wherein the bubble modifier comprises dicaffeoylquinic acids comprising one or more compounds selected from the group consisting of 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, 4,5-dicaffeoylquinic acid, and salts thereof.

32. The modified steviol glycoside solution of claim 27, wherein the steviol glycoside comprises one at least one of rebaudioside A, rebaudioside B, rebaudioside D and rebaudioside M.

33. The modified steviol glycoside solution of claim 27, wherein the steviol glycoside comprises at least 80% (wt) by weight of rebaudioside M based on a total weight of steviol glycoside in the sweetened composition.

34. The modified steviol glycoside solution of claim 27, wherein the sweetened composition has a concentration of steviol glycoside of 100 ppm to 1600 ppm, preferably 200 ppm to 1000 ppm, or more preferably 400 ppm to 800 ppm.

35. The modified steviol glycoside solution of claim 27, wherein the sweetened composition has a concentration of steviol glycoside of 100 ppm to 1600 ppm, preferably 200 ppm to 1000 ppm, or more preferably 400 ppm to 800 ppm and a concentration of bubble modifier of 100 ppm to 1600 ppm, preferably 200 ppm to 1000 ppm, or more preferably 400 ppm to 800 ppm.

36. The modified steviol glycoside solution of claim 27, wherein the sweetened composition comprises a ratio of steviol glycoside to bubble modifier between 1.17 and 2.5, preferably between 1.4 and 2.

37. The modified steviol glycoside solution of claim 27, wherein the sweetened composition has a pH of 2 to 4.

38. (canceled)

39. (canceled)

40. A beverage comprising the sweetened composition of claim 27, wherein the beverage is gasified with one or more gases selected from the group consisting of air, nitrogen, and carbon dioxide.

41.-76. (canceled)
